(19) United States
(12) Patent Application Publication
(10) Pub. No.: US 2026/0300723 A1
(43) Pub. Date: Oct. 1, 2026

(54) SYSTEMS AND METHODS FOR PATHOLOGY DETECTION EXPLAINABILITY

(71) Applicant: GE Precision Healthcare LLC, Waukesha, WI (US)

(72) Inventors: Nati Daniel, Haifa (IL); Hedda Cohen Indelman, Haifa (IL); Elay Dahan, Ramat Gan (IL); Carmit Shiran, Zichron Yaakov (IL); Angeles M. Perez-Agosto, Leander, TX (US); Gopal Biligeri Avinash, Concord, CA (US); Doron Shaked, Kiryat Tivon (IL)

(21) Appl. No.: 19/629,614

(22) Filed: Mar. 26, 2026

Related U.S. Application Data
(60) Provisional application No. 63/780,975, filed on Mar. 31, 2025.

(51) Int. Cl. G06N 3/08

(52) U.S. Cl. CPC G06N 3/08

(57) ABSTRACT

One or more systems, devices, computer program products, and computer-implemented methods relate to adaptive similarity-based assessment of medical image findings using a joint embedding architecture. A system comprises a memory storing computer-executable components and a processor executing the components. An inference component encodes medical data, including a detected finding and a corresponding region of interest, into a joint embedding space using a representation learning model. A score component computes weighted distances between a query embedding and embeddings associated with positive and negative reference cases and normalizes the distances to generate a bounded quality score. A diagnostic support component retrieves representative cases and determines diagnostic quality. An artificial intelligence component trains the representation learning model, and a training component updates model parameters based on user feedback or case relevance to modify spatial relationships within the embedding space for improved subsequent similarity quantification.

### CROSS REFERENCE TO RELATED APPLICATIONS

This application claims priority to and the benefit of U.S. Provisional Patent Application No. 63/780,975, filed on Mar. 31, 2025, the disclosure of which is incorporated herein by reference in its entirety.

### TECHNICAL FIELD

The subject disclosure relates generally to assessing certainty of artificial intelligence models used for detection or segmentation of pathologies and, more specifically, to comparing findings identified by an artificial intelligence model as potential pathologies with a target database of examples.

### BACKGROUND

Artificial intelligence (AI) has significantly transformed medical imaging by providing automated detection and segmentation of pathologies. AI models are increasingly used in clinical decision support systems to enhance diagnostic accuracy and efficiency. These models leverage deep learning techniques to analyze medical images and identify potential abnormalities, offering substantial benefits in fields such as radiology, ultrasound imaging, and pathology detection.

Despite these advancements, AI-based medical image analysis presents several key challenges. One of the most critical issues is the certainty and reliability of AI-generated findings. This uncertainty can lead to a lack of trust in AI-driven diagnostics, particularly in high-stakes medical environments. Additional challenges can stem from the inherent variability of pathological findings. Unlike anatomical structures, which are consistently present across patients, pathological abnormalities can vary widely in appearance, making it difficult for AI models to maintain consistent accuracy. Visually similar features between pathological and non-pathological findings further complicate the differentiation process. This can result in false positives, where benign structures are misclassified as pathological, or false negatives, where genuine pathologies go undetected.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products can facilitate assessing certainty of artificial intelligence models used for detection or segmentation of pathologies.

According to one or more embodiments, a system is provided. The system can comprise a non-transitory computer-readable memory that stores computer-executable components and a processor that executes the computer-executable components. The computer-executable components can include an inference component that processes medical data and encodes the medical data, including a detected finding and a corresponding region of interest, into a joint embedding space using a representation learning model. The computer-executable components can further include a score component that computes distances in the joint embedding space between a query embedding and embeddings associated with positive reference cases and negative reference cases, applies weighting to the computed distances, and normalizes a weighted result to generate a bounded quality score. A diagnostic support component can retrieve representative cases and determine diagnostic quality. An artificial intelligence component can train the representation learning model, and a training component can update model parameters based on user feedback, case relevance, or diagnostic quality determinations to modify spatial relationships within the joint embedding space for subsequent similarity quantification.

According to one or more embodiments, a computer-implemented method is provided. In various embodiments, the computer-implemented method can comprise processing, by a system operatively coupled to a processor, medical data. In various aspects, the computer-implemented method can comprise accessing, by the processor, an embedded representation of a detected finding or a corresponding region of interest. In various aspects, the computer-implemented method can comprise quantifying, by the processor, a similarity between a query image and an at least one reference case. In various instances, the computer-implemented method can comprise generating, by the processor, a quality score. In various instances, the computer-implemented method can comprise retrieving, by the processor representative cases for the detected finding. In various aspects, the computer-implemented method can comprise comparing, by the processor, the representative cases with the medical data. In various instances, the computer-implemented method can comprise determining, by the processor, a diagnostic quality of the data.

According to one or more embodiments, a computer program product for facilitating assessing certainty of artificial intelligence models used for detection or segmentation of pathologies is provided. In various embodiments, the computer program product can comprise a non-transitory computer-readable memory having program instructions embodied therewith. In various aspects, the program instructions can be executable by a processor to cause the processor to process medical data. In various cases, the program instructions can be further executable to cause the processor to access an embedded representation of a detected finding or a corresponding region of interest. In various aspects, the program instructions can be further executable to cause the processor to quantify a similarity between a query image and an at least one reference case. In various cases, the program instructions can be further executable to cause the processor to generate a quality score. In various aspects, the program instructions can be further executable to cause the processor to retrieve representative cases for the detected finding. In various cases, the program instructions can be further executable to cause the processor to compare the representative cases with the medical data. In various cases, the program instructions can be further executable to cause the processor to determine a diagnostic quality of the medical data.

### DESCRIPTION OF THE DRAWINGS

FIG. 1 illustrates a block diagram of an example, non-limiting system that facilitates assessing certainty of artificial intelligence models used for detection or segmentation of pathologies in accordance with one or more embodiments described herein.

FIG. 2 illustrates a block diagram of an example, non-limiting system that facilitates assessing certainty of artificial intelligence models used for detection or segmentation of pathologies in accordance with one or more embodiments described herein.

FIG. 3 illustrates a flow diagram of an example, non-limiting computer-implemented method that facilitates assessing certainty of artificial intelligence models used for detection or segmentation of pathologies in accordance with one or more embodiments described herein.

FIG. 4 illustrates a flow diagram of an example, non-limiting computer-implemented method that facilitates assessing certainty of artificial intelligence models used for detection or segmentation of pathologies in accordance with one or more embodiments described herein.

FIG. 5 illustrates an example, non-limiting system architecture that can facilitate assessing certainty of artificial intelligence models used for detection or segmentation of pathologies in accordance with one or more embodiments described herein.

FIG. 6 illustrates an example, non-limiting system architecture that can facilitate assessing certainty of artificial intelligence models used for detection or segmentation of pathologies in accordance with one or more embodiments described herein.

FIG. 7 illustrates an example, non-limiting system architecture that can facilitate assessing certainty of artificial intelligence models used for detection or segmentation of pathologies in accordance with one or more embodiments described herein.

FIG. 8 illustrates an example, non-limiting system architecture that can facilitate assessing certainty of artificial intelligence models used for detection or segmentation of pathologies in accordance with one or more embodiments described herein.

FIG. 9 illustrates an example, non-limiting system architecture that can facilitate assessing certainty of artificial intelligence models used for detection or segmentation of pathologies in accordance with one or more embodiments described herein.

FIG. 10 illustrates a block diagram of an example, non-limiting operating environment in which one or more embodiments described herein can be facilitated.

FIG. 11 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Artificial intelligence has significantly transformed medical imaging by providing automated detection and segmentation of pathologies. AI models are increasingly used in clinical decision support systems to enhance diagnostic accuracy and efficiency. These models can leverage deep learning techniques to analyze medical images and identify potential abnormalities.

Despite these advancements, AI-based medical image analysis presents several key challenges. For example, AI-generated findings are prone to questions of certainty and reliability. AI models can identify suspicious pathologies, but without an explicit indication of confidence or certainty, medical professionals are left to subjectively interpret the results. An additional challenge stems from the inherent variability of pathological findings. Unlike anatomical structures, which are consistently present across patients, pathological abnormalities can vary widely in appearance, making it difficult for AI models to maintain consistent accuracy. Visually similar features between pathological and non-pathological findings can further complicate the differentiation process, resulting in false positives or false negatives. Additionally, AI models frequently rely on large-scale annotated datasets for training and validation. While these datasets provide a foundation for AI learning, the effectiveness of an AI system can depend on the quality and diversity of the training data. A model trained on a limited dataset can fail to recognize variations in pathology across different patient populations or imaging conditions. Furthermore, issues with explainability and interpretability can make it difficult for medical professionals to assess the reliability of AI recommendations. Scalability is also an issue. Developing specialized AI models for each potential finding can be difficult due to the extensive variability in pathology types and imaging conditions. Clinical decision-making often requires comparison with reference cases. Without the ability to compare AI-detected findings with verified cases, clinicians can be forced to rely solely on personal expertise, limiting the practical utility of AI in diagnostic workflows.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate assessing certainty of artificial intelligence models used for detection or segmentation of pathologies. In particular, the inventors of various embodiments described herein realized that AI models used for medical image analysis often lack a clear certainty assessment, making it difficult for clinicians to interpret the reliability of AI-generated findings. More particularly, the inventors realized that the inherent variability of pathological findings, combined with the visual similarities between pathological and non-pathological structures, leads to inconsistent model performance and potential misclassifications. Specifically, the absence of an explicit confidence indicator can reduce trust in AI-driven diagnostics, limiting their adoption in clinical workflows. Further, the inventors realized that current AI-based pathology detection models do not provide explainability by contextualizing findings with relevant reference cases, preventing clinicians from understanding the basis of AI decisions. Additionally, developing specialized AI models for each type of finding is not scalable, necessitating a more adaptable and generalizable approach to certainty assessment.

Accordingly, various embodiments described herein can be considered as improving certainty assessment of artificial intelligence models used for detection or segmentation of pathologies by enabling a structured, multi-level confidence metric that quantifies AI certainty based on similarity comparisons with verified positive and negative reference cases. The ability to assess AI confidence through similarity scoring can ensure greater transparency in AI-driven medical imaging, allowing clinicians to make informed decisions based on the reliability of detected findings.

Accordingly, systems described herein can enhance model interpretability by retrieving representative cases that contextualize AI-detected findings, thereby providing visual support for diagnostic decisions. Furthermore, systems described herein can enhance scalability in AI-based pathology detection by leveraging joint embedding spaces to assess certainty across a wide range of findings, thereby ensuring that AI-driven diagnostic support remains efficient, adaptable, and clinically relevant.

Various embodiments described herein can be considered as a computerized tool (e.g., any suitable combination of computer-executable hardware or computer-executable software) that can facilitate certainty assessment of artificial intelligence models used for detection or segmentation of pathologies. In various aspects, such computerized tools can comprise an inference component, a score component, a diagnostic support component, a display component, a training component, a user-interface (UI) component, or an artificial intelligence (AI) component.

In various embodiments, the inference component can process medical data and encode the medical data, including a detected finding and a corresponding region of interest, into a joint embedding space as an embedding representation generated by a representation learning model. Medical data can comprise single-frame images, volumetric image data, or time-series imaging data acquired from a medical imaging modality, including X-ray, mammography, computed tomography (CT), magnetic resonance imaging (MRI), ultrasound, fluoroscopy, or other diagnostic imaging systems. The inference component can identify or receive a detected finding, which can comprise an anatomical structure, a pathological feature, a lesion, a tumor, a fracture, a hemorrhage, a fluid accumulation, or other abnormality. The corresponding region of interest can be represented as a bounding box, segmentation mask, voxel mask, polygonal contour, heatmap, or spatial coordinate set defining a localized portion of the medical data. The representation learning model used to generate the embedding representation can comprise a convolutional neural network, a vision transformer, a Siamese network, a metric learning architecture, or a hybrid deep neural network configured to produce high-dimensional embedding vectors. In some embodiments, the inference component can concatenate or otherwise combine image data and region-of-interest information prior to encoding so that both spatial and pathological characteristics are represented in the joint embedding space. The resulting embedding representation can be a vector in a multi-dimensional feature space structured such that embeddings associated with similar clinical findings are positioned closer together and embeddings associated with dissimilar clinical findings are positioned farther apart. The inference component can further perform preprocessing operations, including normalization, contrast enhancement, denoising, resolution adjustment, artifact reduction, or anatomical landmark detection, to ensure consistent encoding into the joint embedding space.

The inference component can operate in conjunction with other system components to enable similarity quantification and adaptive model refinement. In various embodiments, the inference component can provide the embedding representation to a score component that computes distances in the joint embedding space between a query embedding associated with the detected finding and embeddings associated with a plurality of positive reference cases and a plurality of negative reference cases. These embeddings can be stored in one or more databases and can correspond to previously encoded medical images and regions of interest. The distances can be computed using cosine similarity, Euclidean distance, Mahalanobis distance, or other metric-based evaluations. The inference component can further support adaptive learning by interfacing with an artificial intelligence component and a training component that update parameters of the representation learning model. For example, user feedback, relevance determinations of positive and negative reference cases, or determinations of diagnostic quality can be used to fine-tune embedding vectors or adjust similarity weighting factors. Updating the parameters of the representation learning model can modify spatial relationships within the joint embedding space to increase separation between embeddings associated with positive reference cases and embeddings associated with negative reference cases for subsequent similarity quantification. In this manner, the inference component participates in a continuous learning framework that improves embedding discrimination and reduces false positive similarity matches over time.

In various embodiments, the score component can quantify a similarity between a query image and an at least one reference case and generate a quality score. A query image can refer to a medical image submitted for analysis, such as an X-ray, MRI, CT scan, or ultrasound frame, while a reference case can be a previously annotated image stored in a medical database, serving as a benchmark for similarity comparisons. The score component can analyze the relationship between a query image and reference cases by computing a similarity score, which can provide an interpretable measure of how closely the detected finding within the query image aligns with known clinical patterns. The similarity score can facilitate the retrieval of relevant cases and assist clinicians in decision-making by highlighting comparable findings in previously diagnosed cases. To compute the similarity score, the score component can leverage an AI-driven similarity metric, such as cosine similarity, Euclidean distance, or Mahalanobis distance, to quantify how closely the query embedding (a numerical representation of the query image's detected finding) matches the embeddings of stored reference cases. The score component can systematically evaluate distances between the query embedding and both positive and negative reference cases. Positive reference cases can contain the same or a similar clinical finding as the query image, serving as relevant comparisons for validation. Negative reference cases, on the other hand, can consist of images that do not contain the detected finding, allowing the system to contrast true pathological features against visually similar but non-pathological structures. Negative reference cases can contain a different finding. For example, negative reference cases can contain a finding that looks similar, but is in fact a different finding. Negative reference cases can further contain examples of low diagnostic quality. By assessing these distances, the score component can generate a composite similarity score that reflects both the presence and the distinctiveness of the detected finding. The score component can refine calculations by weighing distances differently based on clinical importance and then normalizing the final result within a predefined scale to produce a structured quality score. This quality score can range from a low value, indicating weak similarity and high uncertainty, to a high value, reflecting strong similarity and high confidence in the detected finding. The score component can also be configured to dynamically adjust weight factors based on domain-specific parameters, such as imaging modality, anatomical region, or the severity of a detected pathology. Additionally, the score component can integrate with a user-interface component that allows clinicians to review the retrieved reference cases and adjust similarity thresholds based on expert judgment. In additional embodiments, the score component can perform the similarity quantification within a joint embedding space generated by a representation learning model, wherein the query image and each reference case are encoded as high-dimensional embedding vectors. The score component can compute distances between the query embedding and embeddings associated with a plurality of positive reference cases and a plurality of negative reference cases stored in the joint embedding space. In some embodiments, separate weighting factors can be applied to distances associated with the positive reference cases and distances associated with the negative reference cases, such that contributions of clinically relevant matches and clinically dissimilar examples are differentially emphasized. The weighted distances can be aggregated and normalized to a predefined bounded diagnostic certainty scale, including a scale having a lower threshold representing weak similarity and an upper threshold representing strong similarity. In further embodiments, the score component can identify reference cases having embeddings that are closest to the query embedding among the positive reference cases and reference cases having embeddings that are furthest from the query embedding among the negative reference cases within the joint embedding space. The weighting factors and normalization parameters can be updated by a training component based on user feedback, relevance determinations, or diagnostic quality assessments to reduce false positive similarity matches and improve separation between embeddings associated with positive reference cases and negative reference cases in subsequent similarity quantification.

In various embodiments, the diagnostic support component can retrieve representative cases pertaining to the detected finding and compare the representative cases with the embedded representation of the detected finding to determine a diagnostic quality of the detected finding. The diagnostic support component can retrieve representative cases for the detected finding and compare the representative cases with the medical query data to determine whether the query data exhibits low diagnostic quality. Medical query data can include various imaging modalities such as X-rays, CT scans, MRIs, and ultrasound images, which may be in the form of single-frame images, volumetric datasets, or time-series data from dynamic imaging. The detected finding can be an anatomical structure, a medical feature, anomaly, or condition identified within the query image, and representative cases can refer to previously annotated medical images stored in a database that contain either the same or similar findings (positive reference cases) or images that do not contain the finding (negative reference cases). The diagnostic support component can leverage these reference cases to assess both the quality and reliability of the query data by comparing image characteristics, anatomical positioning, and diagnostic clarity. To assess diagnostic quality, the diagnostic support component can evaluate several key factors, including image resolution, contrast, noise levels, anatomical positioning, and the presence of imaging artifacts. Poor-quality medical images can result in unreliable AI predictions, misinterpretations, or missed diagnoses. The system can determine whether the anatomical positioning of the query image deviates from predefined anatomical landmarks associated with the detected finding. For example, in musculoskeletal ultrasound imaging, incorrect probe placement can result in anisotropy artifacts, shadowing, or poor visibility of key structures. If the system identifies deviations or quality deficiencies, the diagnostic support component can flag the query data as low quality and take corrective action, such as generating an alert or recommendation for image retake, enhancement, or manual review by a clinician. In additional embodiments, the diagnostic support component can retrieve the representative cases based on positions of corresponding embeddings within a joint embedding space generated by a representation learning model. Retrieval can include selecting reference cases having embeddings that are closest to a query embedding among a plurality of positive reference cases and selecting reference cases having embeddings that are furthest from the query embedding among a plurality of negative reference cases within the joint embedding space. The diagnostic support component can compare the embedded representation of the detected finding with embeddings of the representative cases by evaluating spatial relationships within the joint embedding space, including relative distances, clustering behavior, or separation margins between positive and negative cases. In some embodiments, the diagnostic support component can utilize a quality score generated by a score component that computes weighted distances between the query embedding and embeddings associated with positive and negative reference cases and normalizes a weighted result to a predefined bounded diagnostic certainty scale. The diagnostic support component can determine diagnostic quality based at least in part on whether the quality score satisfies a threshold corresponding to weak similarity or high uncertainty. In further embodiments, diagnostic quality determination can incorporate both embedding-space relationships and image-based quality metrics, including resolution, contrast, noise levels, anatomical positioning, and presence of imaging artifacts, to produce a composite diagnostic quality assessment. In additional embodiments, determinations of diagnostic quality can be provided to a training component for updating one or more parameters of the representation learning model. Updating the parameters can modify spatial relationships within the joint embedding space to increase separation between embeddings associated with positive reference cases and embeddings associated with negative reference cases in subsequent similarity quantification. In this manner, the diagnostic support component can participate in a continuous learning framework that improves embedding discrimination and reduces false positive similarity matches over time.

The retrieval of representative cases by the diagnostic support component can provide comparative visual context for the detected finding. The diagnostic support component can select the most relevant positive and negative reference cases by identifying images that are closest or furthest in similarity to the detected finding based on a joint embedding space. This comparison can allow a clinician to verify whether the detected finding in the query image is clinically meaningful or potentially a result of poor imaging quality. Additionally, the diagnostic support component can determine whether low-quality data affects AI-driven findings by analyzing inconsistencies between the retrieved reference cases and the AI-generated output. Furthermore, the diagnostic support component can integrate with the user-interface component, allowing clinicians to override quality assessments, provide feedback on retrieved reference cases, or adjust similarity thresholds based on expertise. This feedback can refine the system over time by enhancing the training of AI models through iterative learning. In additional embodiments, the joint embedding space can comprise a high-dimensional feature space generated by a representation learning model, wherein each reference case and the detected finding are represented as embedding vectors. The diagnostic support component can retrieve representative cases by computing distances between a query embedding associated with the detected finding and embeddings associated with a plurality of positive reference cases and a plurality of negative reference cases stored within the joint embedding space. Retrieval can include selecting reference cases having embeddings that are closest to the query embedding among the positive reference cases and selecting reference cases having embeddings that are furthest from the query embedding among the negative reference cases. In some embodiments, the similarity determinations used for retrieval can correspond to weighted distance computations performed by a score component, wherein distances associated with positive reference cases and distances associated with negative reference cases are weighted differently and normalized to a predefined bounded diagnostic certainty scale. The diagnostic support component can use the resulting quality score to determine whether similarity relationships satisfy predefined thresholds indicative of strong similarity, weak similarity, or elevated uncertainty. In further embodiments, feedback provided through the user-interface component can be supplied to a training component that updates one or more parameters of the representation learning model. Updating the parameters can include fine-tuning embedding vectors, adjusting similarity weighting factors applied to positive and negative reference cases, or modifying loss functions used during contrastive or metric learning. Such updates can modify spatial relationships within the joint embedding space to increase separation between embeddings associated with positive reference cases and embeddings associated with negative reference cases for subsequent similarity quantification. In this manner, the retrieval of representative cases can directly contribute to adaptive refinement of the joint embedding space and reduction of false positive similarity matches over time.

In various embodiments, the training component can train a representation learning model to learn a joint embedding space for the detected finding or the corresponding regions of interest (ROIs). A representation learning model can refer to an artificial intelligence model, such as a deep neural network (DNN), convolutional neural network (CNN), or vision transformer (ViT), that can learn meaningful feature representations from medical imaging data. The representation learning model can map medical images and their detected findings into a joint embedding space. A joint embedding space can comprise a structured mathematical space where similar findings can be represented closer together while dissimilar ones can be positioned further apart. To train this joint embedding space, the training component can leverage self-supervised learning (SSL) techniques, contrastive learning frameworks (e.g., SimCLR, MoCo, BYOL), or metric learning methods (e.g., triplet loss, contrastive loss). The training data can consist of pairs or groups of medical images and their respective findings, along with associated ROIs, which can be represented as bounding boxes, segmentation masks, or spatial coordinates. The model can be trained using a large dataset of annotated medical images, ensuring that it learns robust feature representations across different imaging modalities, anatomical regions, and pathology types. In additional embodiments, the training component can train the representation learning model using a plurality of positive reference cases and a plurality of negative reference cases, wherein embeddings associated with similar clinical findings are optimized to minimize distances within the joint embedding space and embeddings associated with dissimilar clinical findings are optimized to maximize distances within the joint embedding space. In some embodiments, margin-based objectives can be employed to enforce a minimum separation between embeddings associated with positive reference cases and embeddings associated with negative reference cases. In further embodiments, the training component can update one or more parameters of the representation learning model during initial training or during subsequent fine-tuning phases. Updating the one or more parameters can include adjusting network weights, modifying projection head parameters, updating embedding vectors, or recalibrating similarity weighting factors used during distance aggregation. The training component can receive input from a user-interface component, a diagnostic support component, or a score component, including user feedback associated with retrieved representative cases, relevance assessments of positive and negative reference cases, or determinations of diagnostic quality. Such inputs can be incorporated into additional training iterations to refine the joint embedding space. In some embodiments, updating the one or more parameters can modify spatial relationships within the joint embedding space to increase separation between embeddings associated with positive reference cases and embeddings associated with negative reference cases for subsequent similarity quantification. This can reduce false positive similarity matches, improve discrimination between visually similar pathological and non-pathological findings, and enhance robustness across imaging modalities and acquisition conditions. In this manner, the training component can support continuous or periodic re-training, incremental learning, or online adaptation to improve embedding discrimination over time while preserving previously learned representations.

During training, the representation learning model can learn to embed images and findings into a high-dimensional vector space, ensuring that images with similar clinical findings have embeddings that are closer together, while images with different conditions or negative examples are positioned farther apart. This embedding space can be used by other components, such as the inference component (for detecting and classifying findings) or the score component (for computing similarity metrics). The training component can adapt and refine the embedding space over time by incorporating user feedback, newly labeled cases, or expert annotations. If a clinician modifies similarity assessments, corrects detected findings, or refines the relevance of retrieved cases, this feedback can be used to fine-tune the model, ensuring that future similarity calculations are more precise. Furthermore, the training component can be designed to handle multiple types of findings without requiring individual models for each condition, improving the scalability and generalizability of the AI system. In additional embodiments, the training component can refine the joint embedding space by explicitly optimizing distances between a plurality of positive reference case embeddings and a plurality of negative reference case embeddings. Embeddings associated with positive reference cases can be optimized to minimize distance relative to embeddings associated with similar detected findings, while embeddings associated with negative reference cases can be optimized to maximize distance relative to embeddings associated with dissimilar findings. Such optimization can include application of contrastive loss functions, triplet loss, margin-based objectives, or other metric learning formulations that enforce separation constraints within the joint embedding space. In some embodiments, the training component can update one or more parameters of the representation learning model by fine-tuning network weights, projection layers, embedding vectors, or similarity weighting factors used during weighted distance aggregation. Adjustments to similarity weighting factors can alter contributions of distances associated with positive reference cases and distances associated with negative reference cases when generating a quality score. Updating the one or more parameters can modify spatial relationships within the joint embedding space to increase separation between embeddings associated with positive reference cases and embeddings associated with negative reference cases for subsequent similarity quantification. In further embodiments, user feedback associated with retrieved representative cases, relevance determinations of positive and negative reference cases, or determinations of diagnostic quality can be incorporated into iterative training cycles. Such feedback can reduce false positive similarity matches, improve discrimination between visually similar pathological and non-pathological structures, and enhance robustness of similarity quantification across imaging modalities, anatomical regions, and acquisition conditions. The refined embedding space can thereby improve retrieval of reference cases that are closest among positive reference cases and furthest among negative reference cases in future evaluations.

In some embodiments, the display component can provide an interactive visualization interface that presents AI-generated findings, similarity scores, representative cases, or diagnostic quality assessments to a user. The display component can serve as a primary interface for clinicians to review, interpret, and interact with AI-driven results, ensuring that information provided by the system is both accessible and actionable. In some embodiments, the display component can visually present detected findings and corresponding regions of interest within medical query data. These ROIs can be highlighted using bounding boxes, segmentation overlays, heatmaps, or annotated markers to indicate areas of clinical significance. The display component can also integrate with the score component to show a similarity score of a query image relative to its retrieved reference cases. This can include a numerical confidence score, a color-coded certainty scale, or a ranking system that conveys how closely a detected finding matches known cases. The display component can show retrieved representative cases selected by the diagnostic support component, providing both positive and negative reference examples. These representative cases can be displayed side-by-side with the query image, allowing clinicians to compare AI-detected findings with real-world cases that either confirm or contradict the diagnosis. In some embodiments, the display component can include interactive tools that allow users to adjust similarity thresholds, toggle AI-generated markings, or view explainability insights that describe why a particular finding was flagged. In additional embodiments, the display component can present the similarity score on a predefined bounded diagnostic certainty scale having a lower threshold representing weak similarity and a higher threshold representing strong similarity. The bounded scale can be visually represented using graduated indicators, dynamic sliders, bar meters, or other graphical elements that correspond to weighted and normalized distance computations performed within a joint embedding space. The display component can further identify which representative cases correspond to embeddings that are closest to a query embedding among a plurality of positive reference cases and which representative cases correspond to embeddings that are furthest from the query embedding among a plurality of negative reference cases. In some embodiments, the display component can receive user feedback associated with retrieved representative cases, similarity assessments, or diagnostic quality determinations. The user feedback can include relevance ratings, confirmation or rejection of detected findings, adjustments to similarity weighting preferences, or manual reclassification of reference cases as positive or negative. The display component can provide the user feedback to a training component for updating one or more parameters of a representation learning model, including fine-tuning embedding vectors or adjusting similarity weighting factors applied to positive and negative reference cases. Updating the one or more parameters can modify spatial relationships within the joint embedding space to increase separation between embeddings associated with positive reference cases and embeddings associated with negative reference cases for subsequent similarity quantification. In further embodiments, the display component can present visual indicators reflecting how updates to the representation learning model affect subsequent similarity calculations, thereby providing transparency into iterative learning behavior and supporting clinician trust in adaptive model refinement.

In various embodiments, the display component can alert users when low diagnostic quality is detected, as assessed by the diagnostic support component. If the system determines that an image has poor resolution, incorrect anatomical positioning, excessive noise, or imaging artifacts, the display component can generate a warning notification or recommendation suggesting corrective actions. This can include prompts to retake the image, adjust scan parameters, or manually review findings before making clinical decisions. The display component can enable user feedback. Clinicians can confirm or reject AI findings, refine similarity rankings, or override AI-generated annotations through interactive controls. This feedback can then be used to improve the training component by refining the joint embedding space and updating AI similarity assessments. In additional embodiments, low diagnostic quality can be determined based on evaluation of image resolution, contrast, noise levels, anatomical positioning, or presence of imaging artifacts, including deviations from predefined anatomical landmarks associated with a detected finding. When such deviations are identified, the display component can visually highlight the region of concern and present the diagnostic certainty score on a predefined bounded diagnostic certainty scale indicating weak similarity or elevated uncertainty. The display component can further identify whether retrieved representative cases correspond to embeddings that are closest among positive reference cases or furthest among negative reference cases within a joint embedding space, thereby providing contextual justification for the low diagnostic quality assessment. In some embodiments, user feedback associated with low diagnostic quality alerts, similarity rankings, or representative case relevance can be transmitted to a training component that updates one or more parameters of a representation learning model. Updating the one or more parameters can include fine-tuning embedding vectors, recalibrating similarity weighting factors applied to distances associated with positive reference cases and negative reference cases, or modifying loss functions used during contrastive or metric learning. Such updates can modify spatial relationships within the joint embedding space to increase separation between embeddings associated with positive reference cases and embeddings associated with negative reference cases for subsequent similarity quantification. By iteratively incorporating user feedback, the system can reduce false positive similarity matches, improve discrimination between visually similar pathological and non-pathological findings, and enhance robustness of diagnostic quality determinations over time.

In some embodiments, the user-interface component can receive feedback from a user pertaining to relevance of retrieved representative cases, accuracy of detected findings, or quality of diagnostic images. The user-interface component can present AI-generated results in a clear and structured format, enabling users to review similarity scores, retrieved reference cases, and AI-detected findings before making clinical decisions. The user-interface component can modify similarity assessments, update retrieval rankings, or refine quality scores based on the received user feedback. For instance, if a clinician determines that a retrieved reference case is not clinically relevant, they can indicate this, prompting the system to downweigh its similarity contribution in future retrievals. Similarly, if a detected finding is deemed inaccurate or misclassified, the user-interface component can allow the clinician to correct or override the AI's interpretation, feeding this correction back into the system for continuous model refinement. Additionally, the user-interface component can support real-time customization of AI-generated outputs. Users can adjust similarity thresholds, toggle AI annotations such as bounding boxes or segmentation masks, or disable AI-generated markings altogether if manual review is preferred. The system can also capture user interactions, logging feedback trends over time to improve self-supervised learning processes through the training component. In additional embodiments, feedback received through the user-interface component can be provided to a training component that updates one or more parameters of a representation learning model responsible for generating a joint embedding space. Updating the one or more parameters can include fine-tuning network weights, modifying embedding vectors associated with medical images and corresponding regions of interest, recalibrating similarity weighting factors applied to distances associated with positive reference cases and negative reference cases, or adjusting margin parameters used in contrastive or metric learning objectives. In some embodiments, user feedback indicating relevance or irrelevance of retrieved representative cases can be used to reclassify reference cases as positive reference cases or negative reference cases within a plurality of stored cases. Such reclassification can influence subsequent distance computations performed within the joint embedding space. Updating the one or more parameters based on the user feedback can modify spatial relationships within the joint embedding space to increase separation between embeddings associated with positive reference cases and embeddings associated with negative reference cases for subsequent similarity quantification. In further embodiments, adjustments to similarity assessments or quality scores can be reflected in a predefined bounded diagnostic certainty scale, and modifications to similarity weighting factors can alter contributions of distances associated with positive and negative reference cases during weighted distance aggregation. By incorporating user feedback into iterative parameter updates, the system can reduce false positive similarity matches, improve discrimination between visually similar pathological and non-pathological findings, and enhance robustness of similarity-based retrieval across imaging modalities and anatomical regions.

In some embodiments, the artificial intelligence component can train an AI model to quantify a similarity between a query image and an at least one reference case. A query image can refer to a medical image submitted for analysis, while a reference case can be a previously annotated image stored in a database, used as a benchmark for similarity assessment. The AI component can facilitate automated learning, adaptation, and optimization of similarity computations to enhance the accuracy and reliability of medical image retrieval and comparison. The AI component can train a representation learning model that embeds medical images into a joint embedding space, allowing it to measure similarity between the query image and reference cases in a structured mathematical space. The AI component can utilize deep learning architectures, such as convolutional neural networks (CNNs), vision transformers (ViTs), or Siamese networks, to extract and encode visual features of medical findings into high-dimensional vectors. These vector representations can be used by the score component to compute similarity scores, ensuring that images with similar clinical findings have embeddings that are closer together, while dissimilar findings are positioned further apart. In some embodiments, the AI component can implement self-supervised learning (SSL), contrastive learning, or metric learning techniques to improve similarity quantification. It can leverage positive reference cases or negative reference cases to fine-tune its similarity scoring. By training on a diverse dataset of medical imaging modalities, pathologies, and anatomical variations, the AI component can enhance generalizability and robustness across different clinical scenarios. The AI component can integrate with user feedback mechanisms (e.g., the display component) to refine similarity assessments over time. If clinicians modify similarity rankings, correct detected findings, or provide additional annotations, feedback can be incorporated into the AI model's training data to continuously improve similarity quantification accuracy. Additionally, the AI component can support real-time adaptation, allowing it to update similarity scoring models dynamically as new cases and imaging patterns emerge. In additional embodiments, the artificial intelligence component can train the representation learning model to generate embeddings within a joint embedding space such that embeddings associated with a plurality of positive reference cases are positioned closer to embeddings associated with similar clinical findings and embeddings associated with a plurality of negative reference cases are positioned farther apart from embeddings associated with dissimilar clinical findings. Training can include minimizing distances between embeddings corresponding to similar findings and maximizing distances between embeddings corresponding to different findings using contrastive loss functions, triplet loss, margin-based objectives, or other metric learning formulations. In some embodiments, the artificial intelligence component can cooperate with a score component that computes distances in the joint embedding space between a query embedding and embeddings associated with the plurality of positive reference cases and the plurality of negative reference cases. The artificial intelligence component can train parameters that influence weighted distance aggregation, including similarity weighting factors applied to distances associated with positive reference cases and distances associated with negative reference cases. The weighted distances can be normalized to a predefined bounded diagnostic certainty scale, and training can optimize model parameters to improve stability and consistency of the normalized output. In further embodiments, the artificial intelligence component can update one or more parameters of the representation learning model based on user feedback associated with retrieved representative cases, relevance determinations of positive reference cases and negative reference cases, or determinations of diagnostic quality. Updating the one or more parameters can include fine-tuning embedding vectors, adjusting projection layers, recalibrating similarity weighting factors, or modifying margin thresholds used in contrastive objectives. Such updates can modify spatial relationships within the joint embedding space to increase separation between embeddings associated with positive reference cases and embeddings associated with negative reference cases for subsequent similarity quantification. By iteratively refining the joint embedding space, the artificial intelligence component can reduce false positive similarity matches, improve discrimination between visually similar pathological and non-pathological findings, and enhance robustness of similarity-based retrieval over time.

In additional embodiments, reference cases can be organized as a plurality of positive reference cases and a plurality of negative reference cases stored in association with respective embeddings in the joint embedding space. As used herein, medical query data can refer to medical data submitted for analysis and can include a query image and an associated region of interest, and a query embedding can refer to an embedding representation generated by encoding the query image and the associated region of interest using the representation learning model. In various embodiments, the score component can compute distances between the query embedding and embeddings associated with the positive reference cases and the negative reference cases, apply weighting factors to the computed distances, and normalize a weighted result to generate a quality score within a predefined bounded diagnostic certainty scale. The weighting factors can be predetermined, can be selected based on imaging modality, anatomical region, or clinical context, and can be updated through training to adjust contributions of the positive reference cases and the negative reference cases. In some embodiments, the diagnostic support component can retrieve representative cases by selecting reference cases having embeddings that are closest to the query embedding among the positive reference cases and selecting reference cases having embeddings that are furthest from the query embedding among the negative reference cases, and user feedback indicating relevance or irrelevance of retrieved representative cases can be used to reclassify reference cases as positive reference cases or negative reference cases and to update one or more parameters of the representation learning model for subsequent similarity quantification.

Various embodiments described herein can be employed to use hardware or software to solve problems that are highly technical in nature, such as facilitating certainty assessment of artificial intelligence models used for detection or segmentation of pathologies, and that cannot be performed as a set of mental acts by a human. In various embodiments, the disclosed techniques can be implemented using specialized computing resources, including processors, non-transitory computer-readable memories, graphical processing units, hardware accelerators, and software frameworks for executing and training machine learning models. In example implementations, defined acts can include processing medical data; encoding the medical data, including a detected finding and a corresponding region of interest, into a joint embedding space as an embedding representation generated by a representation learning model; computing distances in the joint embedding space between a query embedding and embeddings associated with positive reference cases and negative reference cases; applying weighting to computed distances; normalizing a weighted result to generate a quality score within a predefined bounded scale; retrieving representative cases pertaining to the detected finding; and comparing representative cases with the embedded representation to determine diagnostic quality.

These defined acts are not performed manually by humans. Neither the human mind nor a human with pen and paper can encode medical images and regions of interest into high-dimensional embedding vectors, compute similarity functions across large collections of reference embeddings, and produce a bounded certainty scale output with consistency across modalities and acquisition conditions. In various embodiments, the disclosed operations require machine-executable numerical transformations over high-dimensional vectors and matrices, repeated application of distance metrics, and execution of trained model parameters, which are inherently computer-implemented constructs.

In various embodiments, the disclosed system does not merely output a generic confidence value. Rather, the system can generate a structured quality score by computing distances in a learned joint embedding space relative to both positive reference cases and negative reference cases. This contrastive structure enables the system to quantify not only whether a detected finding resembles known clinical patterns, but also whether the finding is meaningfully separable from visually similar non-pathological structures, different findings, or low diagnostic quality examples. In this manner, the quality score can reflect discriminative structure learned by the representation learning model and can be grounded in retrieved representative cases.

In various embodiments, the joint embedding space can be learned and maintained such that embeddings associated with similar clinical findings are positioned closer together and embeddings associated with dissimilar clinical findings are positioned farther apart. This learned organization of the embedding space is a technical feature that improves how similarity is computed and interpreted for medical imaging data. Rather than relying on static hand-crafted features or fixed thresholds, the system can use learned representations that can generalize across imaging modalities, acquisition settings, anatomical regions, and variations in pathology appearance.

In various embodiments, the score component can compute distances between a query embedding and reference embeddings using metric functions such as cosine similarity, Euclidean distance, or Mahalanobis distance. The score component can further apply different weighting factors to distances associated with positive reference cases and distances associated with negative reference cases. In this way, the system can adjust contributions of supportive evidence and contradictory evidence when generating the quality score. The score component can then normalize a weighted result to a predefined bounded scale to provide a stable and interpretable output for downstream components and user interfaces, including across different data distributions and clinical contexts.

In various embodiments, the diagnostic support component can retrieve representative cases by selecting reference cases having embeddings that are closest to a query embedding among the positive reference cases and selecting reference cases having embeddings that are furthest from the query embedding among the negative reference cases within the joint embedding space. This retrieval behavior provides an operational mechanism for presenting comparative context, reducing ambiguity, and enabling clinicians to evaluate whether the system is producing meaningful similarity-based comparisons or whether the query data is likely impacted by low diagnostic quality conditions.

In various embodiments, the system can determine diagnostic quality based on image resolution, contrast, noise levels, anatomical positioning, or presence of imaging artifacts, and can additionally identify deviations from predefined anatomical landmarks associated with a detected finding. Such determinations can be tied to the similarity-based analysis, for example by identifying patterns where embedding-space relationships are inconsistent with expected positive and negative separation, or where the closest positive cases and furthest negative cases indicate weak discrimination. When low diagnostic quality is detected, the system can generate an alert or recommendation that can prompt corrective action, such as an image retake, parameter adjustment, or manual review.

In various embodiments, the disclosed system can provide an integrated workflow that couples similarity quantification, representative case retrieval, and diagnostic quality assessment in a manner that improves the functioning of the overall machine learning system. For example, the system can identify and surface failure modes caused by poor acquisition conditions or confounding visual features and can do so through a structured pipeline that produces bounded outputs and retrieved explanatory context. This improves reliability and clinical usability relative to systems that only output ungrounded confidence values without representative case context or without contrastive negative evidence.

In various embodiments, the disclosed system can further include an artificial intelligence component that trains the representation learning model and a training component that updates one or more parameters of the representation learning model based on user feedback, relevance of positive and negative reference cases, or determinations of diagnostic quality. By updating model parameters, the system can modify spatial relationships within the joint embedding space to increase separation between embeddings associated with positive reference cases and embeddings associated with negative reference cases for subsequent similarity quantification. This adaptive behavior improves embedding discrimination over time and can reduce false positive similarity matches caused by visually similar but clinically distinct structures.

In various embodiments, the updates can include fine-tuning network weights, adjusting projection layers, updating embedding vectors, or recalibrating similarity weighting factors applied to positive and negative distance contributions. This provides a concrete improvement mechanism tied to machine learning model operation, rather than relying on static or one-time training. The system can thereby adapt to emerging imaging patterns, shifts in modality distributions, and newly observed acquisition artifacts while maintaining a consistent bounded output scale for clinical use.

In various embodiments, user-interface and display components can provide an interactive visualization that presents detected findings, regions of interest, representative cases, and bounded quality scores. The interface can support clinician feedback, such as confirming or rejecting retrieved representative cases, correcting detected findings, indicating that an image appears low quality, or adjusting similarity thresholds for review workflows. Such user interactions can be logged and provided to the training component as structured supervisory signals, enabling iterative refinement of the joint embedding space and similarity weighting behavior.

In various embodiments, the system can improve computational efficiency and scalability by using stored reference embeddings rather than repeatedly performing computationally expensive full-image comparisons. For example, embeddings can be precomputed for reference cases and stored in memory or a database, enabling rapid nearest-neighbor retrieval and distance evaluation in the joint embedding space. This architecture enables high-throughput analysis across large case repositories and supports real-time or near-real-time usage in clinical environments.

In various embodiments, the disclosed approach addresses technical challenges arising from variability in pathological findings and visual overlap between pathological and non-pathological structures. By incorporating negative reference cases, weighted distance aggregation, and bounded normalization, the system can better distinguish between true pathological patterns and confounding patterns that could otherwise lead to unreliable outputs. In addition, retrieval of representative cases offers a practical mechanism for users to validate similarity results and identify scenarios where acquisition artifacts or anatomical positioning issues degrade diagnostic quality.

In various embodiments, the disclosed system can be integrated with medical imaging systems, inference servers, and data repositories to execute the described encoding, similarity computation, retrieval, and training updates using real-world computing infrastructure. The system can thereby support end-to-end operation, including ingest of medical imaging data, embedding generation, similarity scoring, retrieval-based contextualization, diagnostic quality determination, and iterative model updates based on feedback and case relevance signals.

In various embodiments, the diagnostic certainty assessment described herein can be implemented as a structured multi-level quality meter having a predefined number of ordered discrete levels, including embodiments comprising three levels, five levels, seven levels, or other integer-valued level configurations, wherein each level is associated with a defined semantic interpretation corresponding to similarity strength, embedding-space separation characteristics, and diagnostic reliability. In some embodiments, the quality meter can operate independently of a raw classification confidence output of a pathology detection model and can function as an impartial certainty indicator that evaluates structural relationships within a joint embedding space separate from a primary diagnostic label, such that divergence between a classification output and embedding-based similarity structure can indicate potential model failure modes, confounding visual features, acquisition artifacts, incorrect anatomical views, insufficient scan coverage, or distribution shift. Negative reference cases can include visually similar but clinically distinct confounder findings, anatomically adjacent but non-pathological structures, alternate pathologies, low diagnostic quality examples, artifact-corrupted images, out-of-plane acquisitions, incorrect landmark positioning, or modality-specific distortions, thereby explicitly modeling discriminative boundaries within the joint embedding space. In some embodiments, the joint embedding space can be trained and monitored using margin-based separation constraints, clustering-density evaluation, inter-class centroid distance thresholds, or other spatial relationship metrics that detect insufficient separation between embeddings associated with positive reference cases and embeddings associated with negative reference cases as an indicator of elevated uncertainty.

In some embodiments, a single medical image or volumetric dataset can contain multiple detected findings, each associated with a respective region of interest and independently generated embedding representation, such that similarity quantification, representative case retrieval, and quality scoring are performed separately per finding and optionally aggregated at an image-level or study-level using pooling, voting, weighted averaging, or hierarchical attention mechanisms. For volumetric imaging data, including computed tomography or magnetic resonance datasets, slice-wise embeddings can be generated for individual image slices and combined using spatial pooling, sequence models, three-dimensional convolutional aggregation, or attention-based fusion to produce a composite embedding representation. For time-series or cine imaging data, frame-wise embeddings can be temporally aggregated using recurrent networks, temporal convolution, transformer-based sequence modeling, weighted temporal averaging, or motion-aware encoding prior to similarity computation. In some embodiments, embeddings can be generated using local semantic region encoding that preserves spatial context within each region of interest, including multi-scale feature extraction or patch-level attention to support fine-grained similarity discrimination.

In some embodiments, reference case embeddings can be precomputed and stored within a vector index, embedding database, approximate nearest neighbor data structure, hash-based similarity structure, tree-based index, graph-based similarity index, or other scalable vector search framework to enable high-throughput retrieval of closest positive cases and furthest negative cases within the joint embedding space. Embedding storage can support incremental updates, version control, embedding recalibration, and efficient re-indexing when parameters of the representation learning model are updated. In some embodiments, similarity weighting factors applied to distances associated with positive reference cases and distances associated with negative reference cases can be dynamically adjustable based on modality type, anatomical region, pathology category, acquisition protocol, or user-defined clinical priorities, and can be recalibrated during training updates to maintain stability of the predefined bounded diagnostic certainty scale across heterogeneous data distributions.

In some embodiments, the architecture can include a contrastive similarity training subsystem responsible for constructing and periodically refining the joint embedding space using self-supervised learning, contrastive learning, metric learning, or margin-based objectives, and a logically distinct runtime similarity evaluation subsystem responsible for generating query embeddings, computing weighted distances relative to stored positive and negative reference embeddings, normalizing aggregated similarity measures to a bounded certainty scale, and retrieving representative cases for explainability. The training subsystem can support periodic batch retraining, incremental learning, online adaptation, or human-in-the-loop refinement without interrupting inference-stage similarity scoring operations. Feedback signals from user interactions, diagnostic quality determinations, relevance reassessments of positive or negative reference cases, misclassification corrections, or confounder identification can be incorporated into subsequent training iterations to adjust embedding parameters, projection layers, margin thresholds, similarity weighting factors, or normalization parameters. Such updates can modify spatial relationships within the joint embedding space to increase separation between embeddings associated with positive reference cases and embeddings associated with negative reference cases for subsequent similarity quantification, thereby reducing false positive similarity matches and improving discrimination between visually similar pathological and non-pathological findings.

In further embodiments, the system can monitor embedding drift, distribution shift across imaging modalities or acquisition protocols, and stability of normalization ranges within the bounded diagnostic certainty scale, and can recalibrate similarity thresholds, weighting coefficients, or embedding centroids to maintain interpretability and comparability of quality meter outputs over time. The resulting architecture thereby supports scalable multi-finding analysis, confounder-aware discrimination, modality-agnostic embedding calibration, structured multi-level certainty interpretation, failure-mode detection through embedding separation analysis, and adaptive refinement of spatial relationships within the joint embedding space while preserving a stable, interpretable diagnostic certainty output for clinical evaluation.

Accordingly, various embodiments described herein provide concrete computing functionality that improves medical image similarity quantification and diagnostic quality assessment by leveraging learned joint embeddings, contrastive positive and negative case structure, weighted distance aggregation, bounded normalization, representative case retrieval, and adaptive parameter updating. These technical features improve reliability, interpretability, and robustness of similarity-based retrieval and certainty assessment in AI-driven medical imaging workflows.

It should be appreciated that the figures and description herein provide non-limiting examples of various embodiments and are not necessarily drawn to scale.

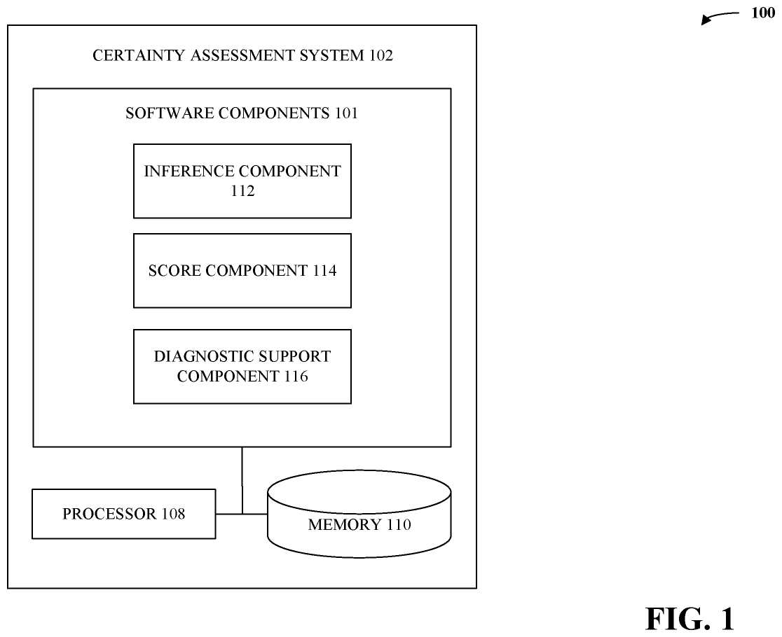

FIG. 1 illustrates a block diagram of an example, non-limiting system 100 that can facilitate certainty assessment of artificial intelligence models used for detection or segmentation of pathologies. In various embodiments, the certainty assessment system 102 can comprise a processor 108 (e.g., computer processing unit, microprocessor) and a non-transitory computer-readable memory 110 that is operably or operatively or communicatively connected or coupled to the processor 108. The non-transitory computer-readable memory 110 can store computer-executable instructions which, upon execution by the processor 108, can cause the processor 108 or other components (e.g., software components 101) of the vulnerability management system 102 (e.g., inference component 112, score component 114, diagnostic support component 116) to perform one or more acts. In various embodiments, the non-transitory computer-readable memory 110 can store computer-executable components (e.g., inference component 112, score component 114, diagnostic support component 116), and the processor 108 can execute the computer-executable components.

In various embodiments, the certainty assessment system 102 can comprise an inference component 112, the inference component 112 can process medical data and access an embedded representation of a detected finding or a corresponding region of interest. Medical data can include various imaging modalities such as single-frame images (e.g., X-rays, mammograms), volumetric data (e.g., CT scans, MRI scans), or time-series data from dynamic imaging (e.g., ultrasound cine loops, fluoroscopy sequences). The inference component 112 can analyze these inputs to extract meaningful features that characterize a detected finding, which can be a medical feature, anomaly, or condition. A detected finding can refer to an abnormal structure or pathology identified within a medical image, such as a tumor, lesion, fracture, or fluid accumulation. A region of interest (ROI) can denote the specific area within the medical image where the finding is localized, which may be represented as a bounding box, segmentation mask, or a set of coordinates. To perform its analysis, the inference component 112 can leverage a trained artificial intelligence model to extract, process, and interpret image features. The inference component 112 can utilize deep learning architectures, such as convolutional neural networks (CNNs) or vision transformers (ViTs), to encode image features into a joint embedding space that facilitates similarity-based retrieval. By operating within a learned embedding space, the inference component 112 can generate standardized feature representations that allow for robust comparison between query images and reference cases. Additionally, the inference component 112 can be designed to operate on preprocessed images or raw medical data, performing necessary transformations such as contrast enhancement, noise reduction, or anatomical landmark detection to optimize its performance. The inference component 112 can also integrate with external medical imaging databases or cloud-based repositories, allowing it to retrieve relevant case references or prior scans for comparative analysis.

The inference component 112 can interact with other system components, such as the score component 114, diagnostic support component 116, and training component 212, to refine its outputs and improve decision-making accuracy. For example, it can feed detected findings into the score component 114 for similarity assessment, enabling the generation of a quality score that quantifies confidence in a given finding. The inference component 112 can also adapt over time by incorporating user feedback and newly labeled cases via the training component 212, allowing for continuous improvement in detection accuracy. In real-time applications, the inference component 112 can process incoming imaging data dynamically, supporting tasks such as image-guided interventions, AI-assisted diagnostics, or automated second-opinion systems. By leveraging advanced AI techniques and structured embeddings, the inference component 112 can enhance clinical workflows, improve diagnostic confidence, and facilitate the efficient analysis of complex medical imaging datasets.

In various embodiments, the certainty assessment system 102 can comprise a score component 114, the score component 114 can quantify a similarity between a query image and an at least one reference case and generate a quality score. A query image can refer to a medical image submitted for analysis, such as an X-ray, MRI, CT scan, or ultrasound frame, while a reference case can be a previously annotated image stored in a medical database, serving as a benchmark for similarity comparisons. The score component 114 can analyze the relationship between a query image and reference cases by computing a similarity score, which can provide an interpretable measure of how closely the detected finding within the query image aligns with known clinical patterns. The similarity score can facilitate the retrieval of relevant cases and assist clinicians in decision-making by highlighting comparable findings in previously diagnosed cases. To compute the similarity score, the score component 114 can leverage an AI-driven similarity metric, such as cosine similarity, Euclidean distance, or Mahalanobis distance, to quantify how closely the query embedding (a numerical representation of the query image's detected finding) matches the embeddings of stored reference cases. The score component 114 can systematically evaluate distances between the query embedding and both positive and negative reference cases. Positive reference cases can contain the same or a similar clinical finding as the query image, serving as relevant comparisons for validation. Negative reference cases, on the other hand, can consist of images that do not contain the detected finding, allowing the system 102 to contrast true pathological features against visually similar but non-pathological structures. Negative reference cases can contain a different finding. For example, negative reference cases can contain a finding that looks similar, but is in fact a different finding. Negative reference cases can further contain examples of low diagnostic quality. By assessing these distances, the score component 114 can generate a composite similarity score that reflects both the presence and the distinctiveness of the detected finding. The score component 114 can refine calculations by weighing distances differently based on clinical importance and then normalizing the final result within a predefined scale to produce a structured quality score. This quality score can range from a low value, indicating weak similarity and high uncertainty, to a high value, reflecting strong similarity and high confidence in the detected finding. The score component 114 can also be configured to dynamically adjust weight factors based on domain-specific parameters, such as imaging modality, anatomical region, or the severity of a detected pathology. Additionally, the score component 114 can integrate with a display component that allows clinicians to review the retrieved reference cases and adjust similarity thresholds based on expert judgment.

In various embodiments, the score component 114 can generate the quality score as a discrete multi-level quality meter comprising a predefined number of ordered certainty levels. For example, the score component 114 can map a normalized similarity value, derived from weighted distances computed between a query embedding associated with a detected finding and embeddings associated with a plurality of positive reference cases and a plurality of negative reference cases within the joint embedding space, to one of a plurality of discrete certainty levels. The predefined number of ordered certainty levels can include, for instance, three levels, five levels, seven levels, or another integer number of levels, each representing a progressively increasing degree of similarity strength and diagnostic reliability. In some embodiments, each certainty level can correspond to a defined range of similarity values based on relative distances to the positive reference cases and separation from the negative reference cases, such that higher certainty levels are associated with smaller distances to embeddings of the positive reference cases and larger distances from embeddings of the negative reference cases. The score component 114 can determine the appropriate certainty level by comparing the normalized quality score to one or more threshold values or boundary conditions associated with the discrete levels. In this manner, the discrete multi-level quality meter provides a structured and interpretable representation of similarity strength that reflects both proximity to clinically relevant reference cases and separation from clinically distinct or confounding reference cases.

In various embodiments, the certainty assessment system 102 can comprise a diagnostic support component 116. The diagnostic support component 116 can retrieve representative cases pertaining to the detected finding and compare the representative cases with the embedded representation of the detected finding to determine a diagnostic quality of the detected finding. The diagnostic support component 116 can retrieve representative cases for the detected finding and compare the representative cases with the medical query data to determine whether the query data exhibits low diagnostic quality. Medical query data can include various imaging modalities such as X-rays, CT scans, MRIs, and ultrasound images, which may be in the form of single-frame images, volumetric datasets, or time-series data from dynamic imaging. The detected finding can be an anatomical structure, a medical feature, anomaly, or condition identified within the query image, and representative cases can refer to previously annotated medical images stored in a database that contain either the same or similar findings (positive cases) or images that do not contain the finding (negative cases). The diagnostic support component 116 can leverage these reference cases to assess both the quality and reliability of the query data by comparing image characteristics, anatomical positioning, and diagnostic clarity. To assess diagnostic quality, the diagnostic support component 116 can evaluate several key factors, including image resolution, contrast, noise levels, anatomical positioning, and the presence of imaging artifacts. Poor-quality medical images can result in unreliable AI predictions, misinterpretations, or missed diagnoses. The system can determine whether the anatomical positioning of the query image deviates from predefined anatomical landmarks associated with the detected finding. For example, in musculoskeletal ultrasound imaging, incorrect probe placement can result in anisotropy artifacts, shadowing, or poor visibility of key structures. If the system identifies deviations or quality deficiencies, the diagnostic support component 116 can flag the query data as low quality and take corrective action, such as generating an alert or recommendation for image retake, enhancement, or manual review by a clinician.

The retrieval of representative cases by the diagnostic support component 116 can provide comparative visual context for the detected finding. The diagnostic support component 116 can select the most relevant positive and negative reference cases by identifying images that are closest or furthest in similarity to the detected finding based on a joint embedding space. This comparison can allow a clinician to verify whether the detected finding in the query image is clinically meaningful or potentially a result of poor imaging quality. Additionally, the diagnostic support component 116 can determine whether low-quality data affects AI-driven findings by analyzing inconsistencies between the retrieved reference cases and the AI-generated output.

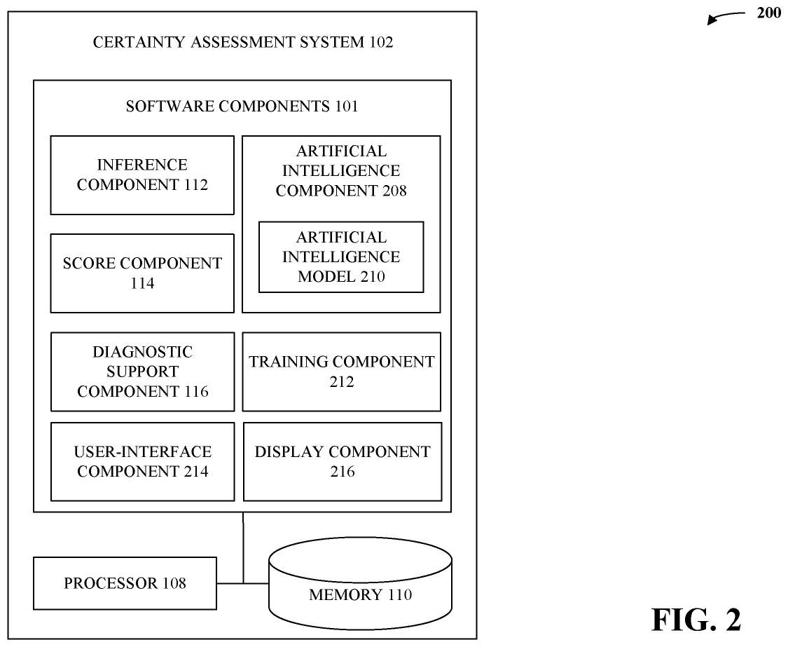

FIG. 2 illustrates a block diagram of an example, non-limiting system 200 that facilitates certainty assessment of artificial intelligence models used for detection or segmentation of pathologies. As shown, the system 200 can, in some cases, comprise the same components as the system 100, and can further comprise an artificial intelligence component 208, a training component 212, a user-interface component 214, and a display component 216.

In various embodiments, the artificial intelligence component 208 can train an AI model 210 to quantify a similarity between a query image and an at least one reference case. A query image can refer to a medical image submitted for analysis, while a reference case can be a previously annotated image stored in a database, used as a benchmark for similarity assessment. The AI component 208 can facilitate automated learning, adaptation, and optimization of similarity computations to enhance the accuracy and reliability of medical image retrieval and comparison, the AI component 208 can train a representation learning model that embeds medical images into a joint embedding space, allowing it to measure similarity between the query image and reference cases in a structured mathematical space. The AI component 208 can utilize deep learning architectures, such as convolutional neural networks (CNNs), vision transformers (ViTs), or Siamese networks, to extract and encode visual features of medical findings into high-dimensional vectors. These vector representations can be used by the score component to compute similarity scores, ensuring that images with similar clinical findings have embeddings that are closer together, while dissimilar findings are positioned further apart. In some embodiments, the AI component 208 can implement self-supervised learning (SSL), contrastive learning, or metric learning techniques to improve similarity quantification. It can leverage positive reference cases or negative reference cases to fine-tune its similarity scoring. By training on a diverse dataset of medical imaging modalities, pathologies, and anatomical variations, the AI component 208 can enhance generalizability and robustness across different clinical scenarios. The AI component 208 can integrate with user feedback mechanisms (e.g., the user-interface component 214, or the display component 216) to refine similarity assessments over time. If clinicians modify similarity rankings, correct detected findings, or provide additional annotations, feedback can be incorporated into the AI model's 210 training data to continuously improve similarity quantification accuracy. Additionally, the AI component 208 can support real-time adaptation, allowing it to update similarity scoring models dynamically as new cases and imaging patterns emerge.

In various aspects, the training component 212 can train a representation learning model to learn a joint embedding space for the detected finding or the corresponding regions of interest (ROIs). A representation learning model can refer to an artificial intelligence model—such as a deep neural network (DNN), convolutional neural network (CNN), or vision transformer (ViT)—that can learn meaningful feature representations from medical imaging data. The representative learning model can map medical images and their detected findings into a joint embedding space. A joint embedding space can comprise a structured mathematical space where similar findings can be represented closer together while dissimilar ones can be positioned further apart. To train this joint embedding space, the training component 212 can leverage self-supervised learning (SSL) techniques, contrastive learning frameworks (e.g., SimCLR, MoCo, BYOL), or metric learning methods (e.g., triplet loss, contrastive loss). The training data can consist of pairs or groups of medical images and their respective findings, along with associated ROIs, which can be represented as bounding boxes, segmentation masks, or spatial coordinates. The model can be trained using a large dataset of annotated medical images, ensuring that it learns robust feature representations across different imaging modalities, anatomical regions, and pathology types. During training, the representative learning model can learn to embed images and findings into a high-dimensional vector space, ensuring that images with similar clinical findings have embeddings that are closer together, while images with different conditions or negative examples are positioned farther apart. This embedding space can be used by other components, such as the inference component (for detecting and classifying findings) or the score component (for computing similarity metrics). The training component 212 can adapt and refine the embedding space over time by incorporating user feedback, newly labeled cases, or expert annotations. If a clinician modifies similarity assessments, corrects detected findings, or refines the relevance of retrieved cases, this feedback can be used to fine-tune the model, ensuring that future similarity calculations are more precise. Furthermore, the training component 212 can be designed to handle multiple types of findings without requiring individual models for each condition, improving the scalability and generalizability of the AI system.

In various aspects, the user-interface component 214 can receive feedback from a user pertaining to relevance of retrieved representative cases, accuracy of detected findings, or quality of diagnostic images. The user-interface component 214 can present AI-generated results in a clear and structured format, enabling users to review similarity scores, retrieved reference cases, and AI-detected findings before making clinical decisions. The user-interface component 214 can modify similarity assessments, update retrieval rankings, or refine quality scores based on the received user feedback. For instance, if a clinician determines that a retrieved reference case is not clinically relevant, they can indicate this, prompting the system to downweigh its similarity contribution in future retrievals. Similarly, if a detected finding is deemed inaccurate or misclassified, the user-interface component 214 can allow the clinician to correct or override the AI's interpretation, feeding this correction back into the system for continuous model refinement. Additionally, the user-interface component 214 can support real-time customization of AI-generated outputs. Users can adjust similarity thresholds, toggle AI annotations such as bounding boxes or segmentation masks, or disable AI-generated markings altogether if manual review is preferred. The system 102 can also capture user interactions, logging feedback trends over time to improve self-supervised learning processes through the training component.

In various aspects, the display component 216 the display component 216 can provide an interactive visualization interface that presents AI-generated findings, similarity scores, representative cases, or diagnostic quality assessments to a user. The display component 216 can serve as a primary interface for clinicians to review, interpret, and interact with AI-driven results, ensuring that information provided by the system is both accessible and actionable. In some embodiments, the display component 216 can visually present detected findings and corresponding regions of interest within medical query data. These ROIs can be highlighted using bounding boxes, segmentation overlays, heatmaps, or annotated markers to indicate areas of clinical significance. The display component 216 can also integrate with the score component to show a similarity score of a query image relative to its retrieved reference cases. This can include a numerical confidence score, a color-coded certainty scale, or a ranking system that conveys how closely a detected finding matches known cases. The display component 216 can show retrieved representative cases selected by the diagnostic support component, providing both positive and negative reference examples. These representative cases can be displayed side-by-side with the query image, allowing clinicians to compare AI-detected findings with real-world cases that either confirm or contradict the diagnosis. In some embodiments, the display component 216 can include interactive tools that allow users to adjust similarity thresholds, toggle AI-generated markings, or view explainability insights that describe why a particular finding was flagged.

In various embodiments, the display component 216 can alert users when low diagnostic quality is detected, as assessed by the diagnostic support component. If the system determines that an image has poor resolution, incorrect anatomical positioning, excessive noise, or imaging artifacts, the display component 216 can generate a warning notification or recommendation suggesting corrective actions. This can include prompts to retake the image, adjust scan parameters, or manually review findings before making clinical decisions. The display component 216 can enable user feedback. Clinicians can confirm or reject AI findings, refine similarity rankings, or override AI-generated annotations through interactive controls. This feedback can then be used to improve the training component by refining the joint embedding space and updating AI similarity assessments.

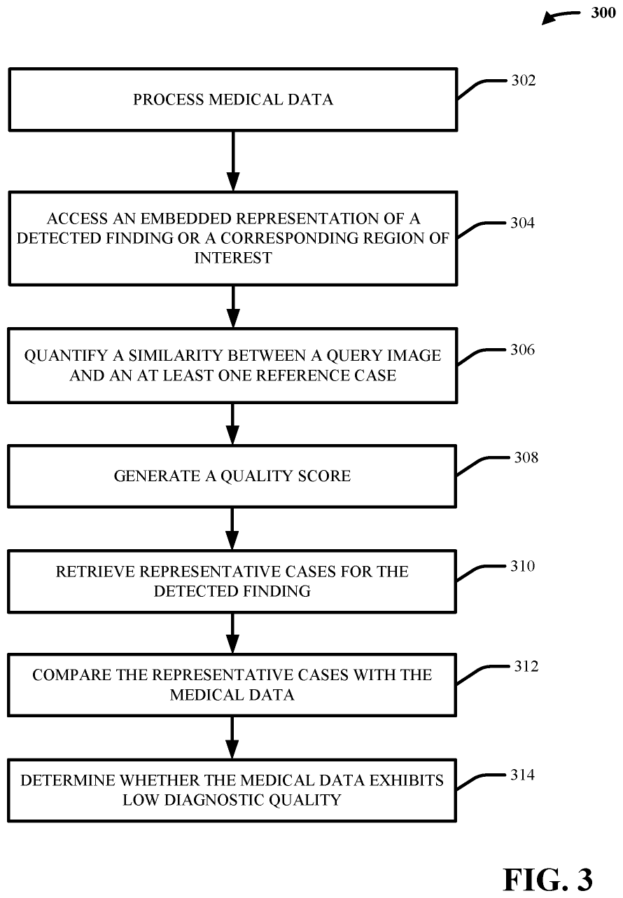

FIG. 3 illustrates a flow diagram of an example, non-limiting computer-implemented method 300 that can facilitate assessing certainty of artificial intelligence models used for detection or segmentation of pathologies in accordance with one or more embodiments described herein.

In various embodiments, act 302 can include processing, by a device (e.g., via 112) operatively coupled to a processor (e.g., 108), medical data. Medical data can encompass a wide range of imaging modalities, including single-frame images (e.g., X-rays, mammograms), volumetric data (e.g., CT scans, MRI scans), and time-series imaging (e.g., ultrasound cine loops, fluoroscopy, dynamic contrast-enhanced MRI). This data may originate from hospital databases, imaging devices, or cloud-based repositories and can require preprocessing to ensure consistency and usability for AI-driven analysis. In some embodiments, act 302 can involve format standardization, noise reduction, image enhancement, and feature extraction. For instance, CT or MRI scans can consist of multiple slices that need to be properly aligned, rescaled, or reconstructed to form a meaningful 3D representation. Similarly, ultrasound images can require speckle noise reduction and contrast enhancement to improve visibility of anatomical structures. Preprocessing techniques such as histogram equalization, edge enhancement, or denoising filters can be applied to enhance the clarity and contrast of medical images before they are analyzed by an AI model. In various implementations, act 302 can also involve contextual data integration, where the system incorporates metadata, clinical history, or imaging protocols alongside the raw image.

In various embodiments, act 304 can include accessing, by a device (e.g., via 112) operatively coupled to a processor (e.g., 108), an embedded representation of a detected finding or a corresponding region of interest. In various embodiments, an embedded representation can refer to a numerical encoding of a medical image or specific pathology that has been generated using deep learning techniques, such as convolutional neural networks (CNNs), vision transformers (ViTs), or self-supervised learning (SSL) models. Such embeddings can exist in a high-dimensional joint embedding space, where similar findings can be positioned closer together while dissimilar ones can be positioned farther apart. By accessing these representations, the system can efficiently compare query images with stored reference cases without needing to rely on raw pixel data. The detected finding can refer to an anatomical structure, a medical feature, anomaly, or condition identified within a processed medical image. Examples can include tumors, lesions, fractures, hemorrhages, anatomical irregularities, or disease markers. Similarly, a corresponding region of interest (ROI) can be defined as a specific area within the image that contains the detected finding, which can be represented as a bounding box, segmentation mask, or key point coordinates. The system can access this information to determine where the pathology is located and how it should be analyzed within the embedding space.

In various embodiments, act 306 can include quantifying, by a device (e.g., via 114) operatively coupled to a processor (e.g., 108), a similarity between a query image and an at least one reference case. A query image can refer to a medical image submitted for analysis, such as an X-ray, MRI, CT scan, or ultrasound frame, while a reference case can be a previously annotated image stored in a medical database, serving as a benchmark for similarity comparisons. Act 306 can include generating a similarity score to provide an interpretable measure of resemblance. The similarity score can be computed using AI-driven similarity metrics, such as cosine similarity, Euclidean distance, or Mahalanobis distance, which can quantify how closely a numerical representation (embedding) of the query image's detected finding matches embeddings of stored reference cases. Act 306 can include systematically evaluating distances between the query embedding and both positive and negative reference cases. Positive reference cases can contain the same or a similar clinical finding as the query image, providing clinically relevant comparisons that can validate the AI-detected finding. Negative reference cases, in contrast, can include images that do not contain the detected finding. Negative reference cases can contain a different finding. For example, negative reference cases can contain a finding that looks similar, but is in fact a different finding. Negative reference cases can further contain examples of low diagnostic quality. These reference cases can be used to distinguish between true pathological features and visually similar but non-pathological structures.

In various embodiments, act 308 can include generating, by a device (e.g., via 114) operatively coupled to a processor (e.g., 108), a quality score. The quality score can reflect both presence and distinctiveness of detected findings. The generated score can be further refined by weighting distances differently based on clinical importance and normalizing a final result within a predefined scale to ensure consistency in scoring. A final quality score can range from a low value (indicating weak similarity and high uncertainty) to a high value (indicating strong similarity and high confidence in the detected finding). In some embodiments, act 308 can include dynamically adjusting weight factors based on domain-specific parameters, such as imaging modality, anatomical region, or a severity of a detected pathology.

In various embodiments, act 310 can include retrieving, by a device (e.g., via 116) operatively coupled to a processor (e.g., 108), retrieves representative cases for the detected finding, a detected finding can refer to a medical feature, anomaly, or condition identified within a query image, such as a tumor, lesion, fracture, hemorrhage, or anatomical irregularity. Representative cases can comprise previously annotated medical images stored in a reference database, serving as clinically relevant examples for comparison. These representative cases can assist in validating AI-detected findings, improving interpretability, and enhancing clinical decision support. Act 310 can include retrieving both positive and negative representative cases to contextualize the detected finding. Positive representative cases can include images that contain the same or a similar clinical finding as the detected anomaly in the query image. Negative representative cases can include images that do not contain the detected finding. In some embodiments, act 310 can be performed using a joint embedding space, where query images and reference cases can be encoded into a structured numerical representation.

In various embodiments, act 312 can include comparing, by a device (e.g., via 116) operatively coupled to a processor (e.g., 108), the representative cases with the medical query data. Act 312 can include evaluating the detected finding within the query image in relation to known clinical cases, providing context for AI-generated results and improving diagnostic confidence. In some embodiments, the comparison can be conducted in a joint embedding space, where both the query image's detected finding and the retrieved representative cases have been encoded into numerical representations. Act 312 can include quality assessment criteria to determine whether the query image exhibits low diagnostic quality that may impact the reliability of AI-generated findings. This assessment can include evaluating image resolution, contrast, noise levels, anatomical positioning, or the presence of imaging artifacts. If discrepancies are detected act 312 can include flagging the medical query data for further review or recommending corrective actions, such as image retake or reprocessing. Act 312 can include presenting results of the comparison to the user via an interactive interface, allowing clinicians to review side-by-side visualizations, similarity scores, and ranked retrieval results.

In various embodiments, act 314 can include determining, by a device (e.g., via 116) operatively coupled to a processor (e.g., 108), a diagnostic quality of the data. Act 314 can include analyzing image attributes such as resolution, contrast, sharpness, noise levels, and the presence of artifacts. Act 314 can include assessing whether the query data meets predefined quality thresholds or if image deficiencies can impact the accuracy of AI-generated findings. Act 314 can include evaluating anatomical positioning by detecting whether the medical image aligns with expected anatomical landmarks for a given modality and region of interest. If deviations are detected, such as incorrect probe placement in ultrasound or poor slice selection in CT or MRI scans, Act 314 can include identifying the query data as having low diagnostic quality. Act 314 can include comparing the query data with retrieved high-quality representative cases to determine whether significant differences in clarity, anatomical correctness, or imaging technique exist. If such differences are present, Act 314 can include classifying the query data as low quality and generating an alert or recommendation indicating potential imaging deficiencies. Act 314 can include generating a quality determination that can be used to inform subsequent analysis, retrieval, or decision-making processes to ensure that medical images used for AI-assisted diagnostics meet clinical quality standards.

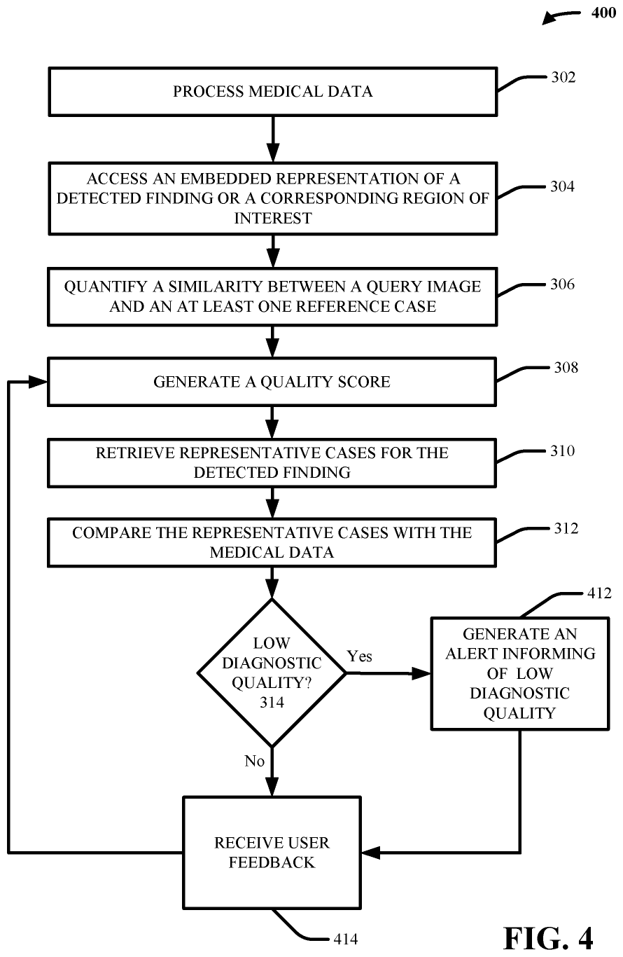

FIG. 4 illustrates a flow diagram of an example, non-limiting computer-implemented method 400 that can facilitate assessing certainty of artificial intelligence models used for detection or segmentation of pathologies in accordance with one or more embodiments described herein. Repeated descriptions of like elements have been omitted for brevity.

If it is determined that the query image exhibits low diagnostic quality, the method 400 can proceed to act 412. If it is determined that the query image exhibits satisfactory diagnostic quality (e.g., does not exhibit low diagnostic quality), the method 400 can proceed to act 414.

In various embodiments, act 412 can include generating, by a device (e.g., via 116) operatively coupled to a processor (e.g., 108), an alert of low diagnostic quality. Act 412 can include issuing an alert based on image deficiencies, such as low resolution, poor contrast, high noise levels, anatomical misalignment, or the presence of imaging artifacts. Act 412 can include determining the severity of the quality issue and selecting an appropriate alert level. For example, if the image resolution is slightly below the acceptable threshold, Act 412 can include generating a low-priority notification, whereas if the image contains severe distortions or incorrect anatomical positioning, Act 412 can include issuing a high-priority alert requiring immediate attention. Act 412 can include presenting the low diagnostic quality alert through a visual, auditory, or system-integrated notification, informing users that the query data may not be suitable for AI-assisted analysis. The alert generated by Act 412 can include specific recommendations for corrective actions, such as retaking the image, adjusting imaging parameters, or manually reviewing AI-detected findings before proceeding. Act 412 can include transmitting the alert to relevant clinical systems, devices, or personnel, ensuring that low-quality diagnostic images are properly flagged for review.

In some embodiments, act 414 can include receiving, by a device (e.g., via 214 or 216) operatively coupled to a processor (e.g., 108), feedback from a user. Act 414 can include capturing user input related to the accuracy, relevance, or confidence of AI-assisted results, allowing for refinement and improvement of subsequent analyses. Act 414 can include receiving feedback in various forms, such as manual corrections to AI-detected findings, adjustments to similarity rankings, confirmations or rejections of retrieved representative cases, or modifications to diagnostic quality assessments. Users may provide feedback through an interactive interface, annotation tools, or structured input fields, enabling precise and clinically relevant refinements to AI-driven outputs. Act 414 can include processing user feedback to dynamically adjust similarity thresholds, modify weighting factors in retrieval models, or refine quality assessment criteria. Feedback received through Act 414 can also be incorporated into ongoing model training or self-supervised learning processes, ensuring that the system continuously adapts based on expert user interactions. Act 414 can include logging received feedback for auditability, performance monitoring, or compliance tracking, allowing for traceability of user interactions and modifications. Additionally, Act 414 can include integrating user feedback into AI-driven decision-support workflows, ensuring that AI-assisted diagnostics align with clinician expertise and evolving medical best practices.

In various embodiments, the method 400 can include returning to act 308. This iterative process can enhance the accuracy, reliability, and adaptability of AI-driven diagnostic support by continuously updating similarity rankings, reference case retrieval, and quality evaluations. In some embodiments, returning to Act 308 can occur when user feedback (received in Act 414) indicates that the initially retrieved representative cases are not sufficiently relevant or when an alert of low diagnostic quality (generated in Act 412) suggests that query data needs further validation. By iterating through Act 308, the system can recompute similarity scores, identify more appropriate reference cases, or refine the embedding space to better align with clinical expectations. Additionally, the iterative approach facilitated by Act 414 can support continuous learning and optimization of AI models. If user feedback identifies incorrect similarity rankings, false-positive findings, or misclassified negative cases, the system can leverage this input to adjust similarity thresholds, reweight embeddings, or update decision criteria before re-executing Act 308. This ensures that AI-assisted diagnostics remain adaptive, responsive to user input, and aligned with real-world medical decision-making.

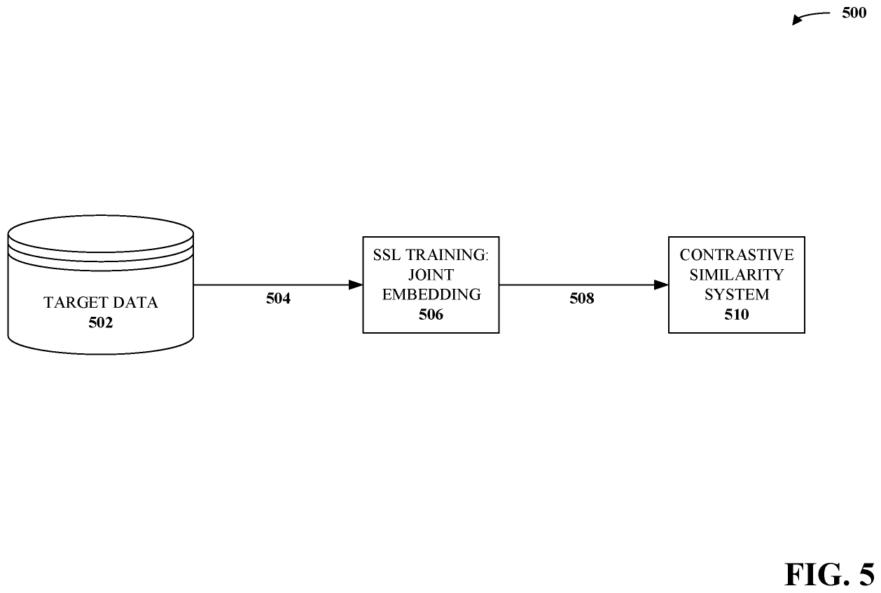

Next, FIG. 5 illustrates an example, non-limiting system architecture 500 that can facilitate assessing certainty of artificial intelligence models used for detection or segmentation of pathologies in accordance with one or more embodiments described herein.

System architecture 500 can include target data 502. Target data 502 can serve as the foundational dataset used for training, similarity assessment, and retrieval in the system architecture 500. Target data 502 can include a structured collection of medical images, corresponding regions of interest (ROIs), and labeled findings, forming the basis for training AI models, refining similarity calculations, and enabling certainty assessment in pathology detection and segmentation. In some embodiments, target data 502 can consist of paired datasets, where each pair includes an image and its associated ROI or location of a detected finding. The ROIs can be semantically significant areas within the image, highlighting key anatomical structures or pathological regions that are essential for similarity ranking and retrieval. These ROIs can be represented as bounding boxes, segmentation masks, or annotated overlays that delineate the precise location of findings within the medical images. Target data 502 can be used to train a joint embedding space that can enable efficient similarity-based retrieval of cases. This embedding space can be generated by training a domain-specific self-supervised learning (SSL) model, which can learn to map images and ROIs into a structured high-dimensional space. The training process can leverage pretrained models to establish an initial feature representation, followed by fine-tuning on domain-specific medical data to optimize similarity assessments for pathology detection. In various embodiments, target data 502 can be treated as a multi-label dataset, where each image-ROI pair can contain multiple findings. This can allow the AI model to recognize and differentiate multiple pathologies within a single image, ensuring that similarity comparisons account for the full diagnostic complexity of real-world medical imaging. Additionally, target data 502 can incorporate color layers or contrast adjustments within the input images to enhance ROI differentiation, improve segmentation accuracy, and facilitate interpretability in AI-driven diagnostics.

System architecture 500 can include arrow 504. Arrow 504 can represent the transfer of structured data from target data 502 to SSL Training 506, facilitating the learning of a joint embedding space for medical image similarity assessment. Action 504 can facilitate the structured transfer of images, ROIs, and findings (I, L, F) into the SSL Training 506 module, ensuring that the training process captures both spatial and pathological relationships. This structured representation can enable the AI model to learn meaningful feature mappings, improving its ability to compare query images with representative cases and assess certainty in AI-driven pathology detection.

System architecture 500 can include SL Training: Joint Embedding 506, which can facilitate the training of a representation learning model to generate a joint embedding space for medical images, regions of interest (ROIs), and findings. This embedding space can enable efficient similarity-based retrieval by mapping images with similar clinical features closer together while pushing dissimilar cases farther apart. In some embodiments, SSL Training 506 can receive structured data (I, L, F) from target data 502 via action arrow 504, where I represents images, L represents ROI locations (bounding boxes or segmentation masks), and F represents findings. Using this structured data, SSL Training 506 can train an AI model to generate embeddings that capture both visual and clinical similarities between different cases. SSL Training 506 can leverage self-supervised learning (SSL) techniques, which allow the model to learn meaningful representations without requiring explicit manual labels for every image. This approach can include contrastive learning methods such as SimCLR, MoCo, or BYOL, where the model learns by maximizing similarity between transformed versions of the same image while distinguishing between different images. By training on a diverse dataset of medical images, SSL Training 506 can improve the system's ability to generalize across different modalities, anatomical structures, and pathology types. Additionally, SSL Training 506 can be designed to handle multi-label learning scenarios, where each image-ROI pair can contain multiple findings.

System architecture 500 can include arrow 508, which can represent the transfer of joint embedding models from SSL Training 506 to Contrastive Similarity System 510. Arrow 508 can facilitate the movement of learned feature representations, denoted as E(I+L; F), where I can represent medical images, L can represent regions of interest (ROIs) such as bounding boxes or segmentation masks, and F can represent findings associated with the images. This transfer can enable the system to utilize the structured numerical embeddings for similarity-based retrieval, ranking, and certainty assessment in AI-driven pathology detection and segmentation. The joint embedding models transferred via arrow 508 can allow Contrastive Similarity System 510 to process and compare encoded representations of medical images, ensuring that images with similar clinical findings are positioned closer together within the embedding space, while dissimilar cases remain farther apart. By utilizing E(I+L; F), the system can perform efficient similarity quantification, allowing for improved retrieval of clinically relevant reference cases. The embedding models can also enhance the certainty assessment of AI-driven findings by structuring image representations in a way that prioritizes clinically significant patterns over incidental similarities. In some embodiments, the joint embedding models transferred through arrow 508 can allow the system to refine contrastive similarity calculations, ensuring that the retrieval and ranking of medical cases align with real-world diagnostic expectations. Additionally, by leveraging structured embeddings that account for both anatomical and pathological variations, the system can provide more explainable and trustworthy AI-assisted findings. Through this transfer, Contrastive Similarity System 510 can utilize pre-trained and continuously refined embeddings to improve certainty assessments, enhance clinical decision support, and optimize AI-driven similarity evaluations.

System architecture 500 can include Contrastive Similarity System 520, which can facilitate the evaluation of similarity between a query image and reference cases by leveraging a joint embedding space. Contrastive Similarity System 520 can utilize the joint embedding models (E(I+L; F)) received from SSL Training 506 via arrow 508 to compare medical images based on their encoded representations rather than raw pixel data. This approach can enable more precise, scalable, and clinically relevant similarity assessments by structuring image comparisons within a high-dimensional mathematical space. Contrastive Similarity System 520 can quantify similarity by analyzing the distance between a query image embedding and the embeddings of positive and negative reference cases. Positive reference cases can include images that contain the same or similar clinical findings as the query image, while negative reference cases can include images that do not contain the detected finding but may have visually similar features. Negative reference cases can contain a different finding. For example, negative reference cases can contain a finding that looks similar, but is in fact a different finding. Negative reference cases can further contain examples of low diagnostic quality. By distinguishing between these cases, Contrastive Similarity System 520 can enhance retrieval accuracy, reduce false positives, and improve certainty assessment in AI-assisted medical imaging. In some embodiments, Contrastive Similarity System 520 can utilize contrastive learning techniques to refine similarity calculations. These techniques can include cosine similarity, Euclidean distance, Mahalanobis distance, or other metric-based evaluations to determine how closely a detected finding aligns with clinically validated cases. Additionally, Contrastive Similarity System 520 can weigh similarity scores based on clinical importance, anatomical region, or imaging modality, ensuring that retrieved reference cases remain highly relevant for diagnosis and decision support. Contrastive Similarity System 520 can integrate with retrieval and ranking mechanisms that prioritize the most relevant cases for clinical review. The system can also provide certainty assessments by computing a quality score based on the similarity rankings.

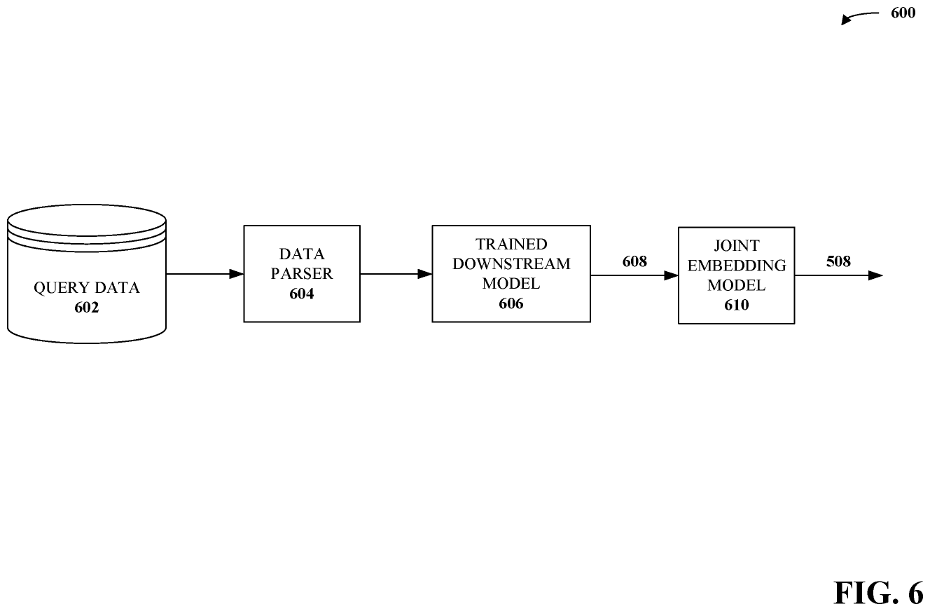

FIG. 6 illustrates an example, non-limiting system architecture 600 that can facilitate assessing certainty of artificial intelligence models used for detection or segmentation of pathologies in accordance with one or more embodiments described herein. Repeated descriptions of like elements have been omitted for brevity.

602 can comprise query data. Query data 602 can comprise medical imaging data submitted for AI-assisted analysis, enabling the system to assess certainty in detection or segmentation of pathologies. Query data 602 can include 2D or 3D medical images from various imaging modalities, such as X-rays, CT scans, MRI scans, ultrasound images, or dynamic time-series sequences. Query data 602 can serve as the input for downstream AI-driven inference processes, allowing the system to extract regions of interest (ROIs), detect medical findings, and generate structured embedding representations for similarity-based retrieval. In some embodiments, query data 602 can be preprocessed and parsed into a sequence of 2D images while maintaining the original order and spatial relationships within the dataset. For example, if the query data comprises a 3D volumetric scan or a time-series sequence, the system can extract individual 2D slices or frames, ensuring that the diagnostic context remains intact and consistent with the original imaging study. This process can allow for more granular analysis of pathology progression and enable the system to capture fine-grained anatomical and pathological details. Query data 602 can be passed through trained AI models to detect regions of interest (L) and findings (F). The system can analyze each 2D query image (I) to determine spatially significant locations where abnormalities may be present, assigning corresponding findings to those locations. These findings can include, but are not limited to, tumors, lesions, fractures, hemorrhages, fluid collections, or anatomical irregularities. Once detected, the query data 602 can be embedded into a joint embedding space as E(I+L; F), allowing for structured comparison against known reference cases. Additionally, query data 602 can support multi-finding detection, where multiple ROIs and corresponding findings can be embedded simultaneously for a given query image. This capability can improve certainty assessment and retrieval accuracy, ensuring that the system accounts for complex cases involving multiple overlapping pathologies. Query data 602 can also be dynamically updated, allowing for the incorporation of new imaging data, repeated scans, or real-time image acquisition to enhance adaptive learning and model refinement.

604 can comprise a data parser. Data parser 604 can facilitate the structured processing of query data 602, enabling the system to parse, format, and organize medical imaging data for AI-assisted analysis. In some embodiments, data parser 604 can handle both 2D and 3D medical imaging sequences, ensuring that data is properly structured before being passed to downstream AI models for detection, segmentation, and similarity assessment. Data parser 604 can extract individual 2D images from multi-dimensional datasets, including 3D volumetric scans (e.g., CT or MRI) or time-series imaging (e.g., ultrasound cine loops, fluoroscopy, or dynamic contrast-enhanced MRI). The parser can maintain the original order of images within a dataset, ensuring that spatial and temporal relationships are preserved for accurate pathology detection and progression analysis. If the query data comprises a multi-slice 3D scan, data parser 604 can sequentially process slices while retaining anatomical consistency across frames. Similarly, in the case of dynamic imaging sequences, the parser can analyze frame-by-frame changes, allowing AI models to detect motion-based abnormalities, contrast flow, or functional characteristics of organs and tissues. In some embodiments, data parser 604 can perform image preprocessing tasks, such as format standardization, resolution adjustments, noise reduction, or artifact correction. These operations can optimize medical images for AI-based feature extraction, ensuring that findings are detected with high precision. Additionally, the parser can normalize image intensities, apply spatial transformations, or rescale images to align with the model's expected input dimensions, further improving diagnostic accuracy. Data parser 604 can also handle metadata extraction and integration, where patient-specific imaging parameters, modality information, scan protocols, and acquisition settings can be processed alongside raw image data. This metadata can be used to enhance certainty assessment, ensuring that AI-generated findings are interpreted in the context of clinically relevant imaging conditions.

606 can comprise a trained downstream model. Trained downstream model 606 can facilitate the detection, segmentation, and feature extraction of medical findings from parsed query data. Trained downstream model 606 can process 2D and 3D medical images that have been structured by data parser 604, enabling the identification of regions of interest (ROIs) and corresponding clinical findings (F). Trained downstream model 606 can be designed to analyze various imaging modalities, including X-ray, MRI, CT, ultrasound, and dynamic imaging sequences, ensuring robust performance across different medical domains. In some embodiments, trained downstream model 606 can employ deep learning architectures, such as convolutional neural networks (CNNs), vision transformers (ViTs), or hybrid AI models, to extract clinically significant features from medical images. Trained downstream model 606 can apply automated segmentation techniques, including bounding boxes and semantic masks, to precisely delineate pathological structures, anatomical regions, or abnormal tissue patterns. Trained downstream model 606 can generate L (locations) of findings (F) within query images (I), allowing for structured embedding and retrieval in later stages of AI-assisted medical analysis. Trained downstream model 606 can also be optimized for multi-label classification, enabling trained downstream model 606 to identify multiple findings within a single image. This capability can enhance diagnostic certainty by ensuring that trained downstream model 606 does not overlook overlapping or coexisting conditions, such as the simultaneous presence of a fracture and soft tissue swelling in an X-ray image. Additionally, trained downstream model 606 can refine detection accuracy by incorporating context-aware learning techniques, spatial attention mechanisms, and uncertainty quantification methods to prioritize clinically relevant regions over incidental image features. In some implementations, trained downstream model 606 can interact with self-supervised learning (SSL) models to continuously refine its feature extraction capabilities. By leveraging real-world medical cases, expert-annotated datasets, and user feedback, trained downstream model 606 can improve its ability to distinguish between true pathological findings and imaging artifacts, ensuring greater accuracy and reliability in AI-assisted diagnostic workflows.

System architecture 600 can include arrow 608, which can represent the transfer of structured medical data from trained downstream model 606 to joint embedding model 610. Arrow 608 can facilitate the movement of processed medical images (I), detected regions of interest (L), and corresponding findings (F) in the form of {I+L, F}, ensuring that these structured representations are embedded into a joint feature space for similarity-based retrieval and certainty assessment. In some embodiments, arrow 608 can enable trained downstream model 606 to provide localized detection results, including bounding box coordinates, segmentation masks, and pathology classifications, which can then be transformed by joint embedding model 610 into structured numerical embeddings. This process can allow the system to compare query images with reference cases using learned feature representations rather than raw pixel data, improving computational efficiency and retrieval precision. Arrow 608 can support multi-label processing, where trained downstream model 606 can provide multiple detected findings and corresponding ROIs per image. By transferring this structured data through arrow 608, joint embedding model 610 can generate embeddings that account for multiple pathologies simultaneously, ensuring that similarity assessments reflect complex diagnostic cases rather than isolated features.

610 can comprise joint embedding model 610. Joint embedding model 610 can facilitate the generation of structured feature representations for medical images, regions of interest (ROIs), and detected findings. Joint embedding model 610 can receive processed query data from trained downstream model 606 and encode it into a joint embedding space, where similar cases can be positioned closer together, and dissimilar cases can be pushed farther apart. This structured embedding representation can enable efficient similarity-based retrieval, certainty assessment, and clinical decision support. In some embodiments, joint embedding model 610 can generate embeddings based on I (images), L (ROI locations), and F (findings), producing E(I+L; F) as a structured representation of the medical query data. This embedding process can ensure that both spatial and pathological relationships within medical images are captured in a format that facilitates comparison, ranking, and retrieval. Joint embedding model 610 can leverage self-supervised learning (SSL), contrastive learning, or metric learning techniques to improve its ability to differentiate between clinically meaningful similarities and incidental image features. Joint embedding model 610 can be optimized to handle multi-label classification, allowing joint embedding model 610 to represent multiple findings within a single image. This capability can enhance diagnostic accuracy by ensuring that joint embedding model 610 captures coexisting or overlapping pathologies in a structured manner. Additionally, joint embedding model 610 can integrate domain-specific weighting techniques, prioritizing clinically significant findings over less relevant image features to improve retrieval accuracy. Joint embedding model 610 can interact with downstream components, such as contrastive similarity system 620, to enable robust similarity comparisons between query images and reference cases.

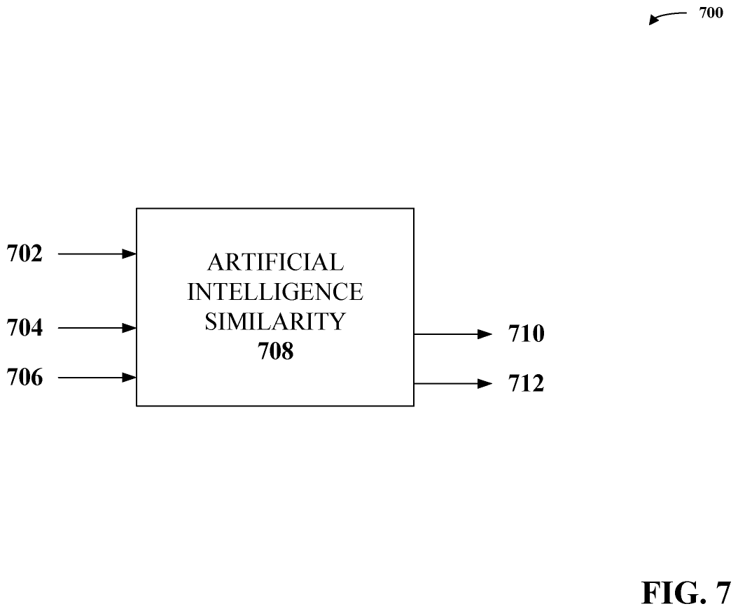

FIG. 7 illustrates an example, non-limiting system architecture 700 that can facilitate assessing certainty of artificial intelligence models used for detection or segmentation of pathologies in accordance with one or more embodiments described herein. Repeated descriptions of like elements have been omitted for brevity.

AI Similarity System (ASS) architecture 700 can operate within a joint embedding space to compute similarity scores between a query image embedding (E_{Q}) and a set of positive (E_{PT}) and negative (E_{NT}) target embeddings. The system 700 can enable certainty assessment and similarity-based retrieval by quantifying how closely a detected finding in a query image aligns with known clinical cases. The similarity score can serve as the foundation for generating a Quality Meter Score, which can provide an interpretable confidence level ranging from 1 (poor match) to 5 (accurate match).

Arrow 702 can represent the embedding of the query image (I) with its associated region of interest (L) and detected finding (F) within the joint embedding space. This embedding can allow the system to encode spatial, pathological, and anatomical features of the query image in a format suitable for distance-based similarity evaluation.

Arrow 704 can represent the set of positive target cases (E_{PT}), where each case contains a clinically similar finding (F) to the query image. This set can be of size M, meaning the system 700 can retrieve and analyze M relevant cases to determine how closely the query image aligns with known positive examples. These embeddings can provide a reference point for assessing whether the detected finding in the query image is consistent with previously validated clinical cases.

Arrow 706 can represent the set of negative target cases (E_{NT}), where each case does not contain the detected finding (F). This set can be of size K, meaning the system can compare the query image against K non-relevant cases to ensure that the detected finding is distinguishable from visually similar but non-pathological structures.

Box 708, labeled AI Similarity, can perform similarity calculations using an AI-driven metric, such as cosine similarity, Euclidean distance, or Mahalanobis distance. The similarity system can evaluate the distance (Dₘ) between the query embedding E_{Q}(I+L; F) and the M positive target cases, as well as the distance (Dₖ) between the query embedding and the K negative target cases. These distances can be weighed differently (wₘ for positives, wₖ for negatives) based on clinical relevance, ensuring that more important cases contribute more significantly to the final similarity assessment. For example, a Quality Meter Score that is based on the cosine similarity metric could take the following form:

$$Quality Meter Score = round ( \overline{{D}_{m}} - \overline{{D}_{k}} + 3 ) ∈ \{ 1 , 2 , .. , 5 \} ,$$

$$where$$

$$\overline{{D}_{m}} = \frac{{\sum }_{i = 1}^{M} {D}_{mi}}{M} ,$$

$$\overline{{D}_{K}} = \frac{{\sum }_{i = 1}^{K} {D}_{ki}}{K} ,$$

$$or$$

$$\overline{{D}_{m}} = {max}_{i ∈ \{ 1 , .. M \}} \{ {D}_{mi} \} ,$$

$$\overline{{D}_{k}} = {max}_{i ∈ \{ 1 , .. K \}} \{ {D}_{ki} \}$$

to ensure that the similarity score is normalized within a scale of 1 to 5, where 1 represents a poor match and 5 represents a highly accurate match.

System architecture 700 can include arrows 710 and 712, which can represent the output of AI Similarity 708 after computing similarity scores between the query image embedding (E_{Q}) and the sets of positive (E_{PT}) and negative (E_{NT}) target embeddings. These outputs can be used to calculate the final Quality Meter Score, providing a structured certainty assessment of how well the detected finding aligns with known clinical cases.

Arrow 710 can represent Dₘ, which can be the computed distance between the query image embedding E_{Q}(I+L; F) and the M positive target cases (E_{PT}). A lower Dₘ value can indicate that the query image is highly similar to positive cases, suggesting that the detected finding is strongly validated by past clinically confirmed cases. Conversely, a higher Dₘ value can indicate that the detected finding does not closely match known positive cases, reducing certainty in the AI-generated result.

Arrow 712 can represent Dₖ, which can be the computed distance between the query image embedding E_{Q}(I+L; F) and the K negative target cases (E_{NT}). A higher Dₖ value can indicate that the detected finding is distinct from non-pathological cases, reinforcing that the detected finding is clinically significant rather than an incidental feature or imaging artifact. Conversely, a lower Dₖ value can suggest that the query image shares features with negative cases, which can indicate a false positive detection or an ambiguous finding requiring further review.

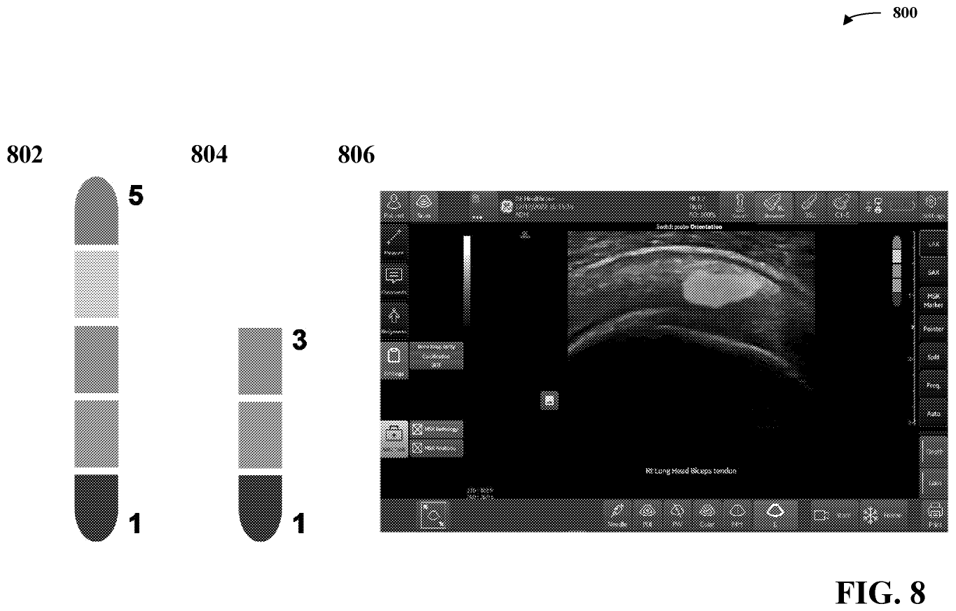

Next, FIG. 8 illustrates an example, non-limiting system architecture 800 that can facilitate assessing certainty of artificial intelligence models used for detection or segmentation of pathologies in accordance with one or more embodiments described herein. Repeated descriptions of like elements have been omitted for brevity.

Quality meter system architecture 800 illustrates an example five-level indicator system designed to assess the certainty and correctness of AI-generated findings in medical imaging analysis. The quality meter can evaluate the similarity between a detected finding and reference cases based on the presence of relevant anatomical or pathological landmarks, ensuring that AI-driven assessments align with clinically validated standards. The quality meter can quantify AI model certainty using a five-level scale of certainty levels, where each certainty level can represent a degree of alignment between AI-detected findings and reference cases. A score of 1 can indicate that the detected finding does not match any reference cases and that no objective data can be gathered, which can suggest a false positive detection, an unrecognized pathology, or poor image quality. A score of 2 can indicate that the detected finding weakly matches a few reference cases but that the similarity is insufficient for diagnosis, which can suggest that the finding is ambiguous, underrepresented in the dataset, or misclassified. A score of 3 can indicate that the detected finding moderately matches several reference cases, providing a similarity level that is sufficient for diagnosis but with some technical limitations or inconsistencies. A score of 4 can indicate that the detected finding strongly matches most reference cases, meaning the diagnosis is easily supported by AI-driven similarity analysis and that the model has high confidence in the correctness of its assessment. A score of 5 can indicate that the detected finding accurately matches relevant reference cases, ensuring that the diagnosis is fully supported by the AI model and maximizing both AI certainty and clinical interpretability.

FIG. 8 can further provide visual examples of how a quality meter can be applied in different AI certainty scenarios. In scenario 802, the quality meter can assign a score of 5, indicating that the detected finding accurately aligns with reference cases, confirming a high-confidence diagnosis. In scenario 804, the quality meter can assign a score of 3, meaning that while the finding is somewhat similar to reference cases, technical or diagnostic flaws reduce confidence in AI interpretation. FIG. 8 depict a scenario 806 where a quality meter is integrated into a musculoskeletal (MSK) preset graphical user interface (GUI).

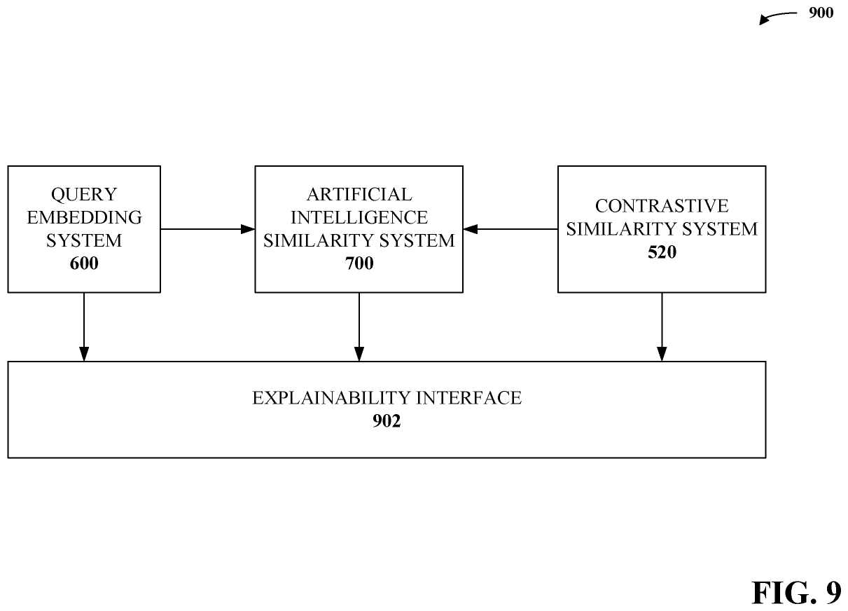

Next, FIG. 9 illustrates an example, non-limiting system architecture 900 that can facilitate assessing certainty of artificial intelligence models used for detection or segmentation of pathologies in accordance with one or more embodiments described herein. Repeated descriptions of like elements have been omitted for brevity. The explainability interface 902 can receive inputs from system architecture 600 (inference stage), system architecture 700 (AI similarity system), and system architecture 520 (contrastive similarity system) to present retrieved representative cases, similarity scores, and quality meter assessments in an interactive and interpretable format. Explainability interface 902 can facilitate the retrieval of positive and negative reference cases for each detected finding in a patient's query image. By leveraging outputs from the AI similarity system 700 and contrastive similarity system 520, explainability interface 902 can present the most relevant positive cases, which contain similar clinical findings, and the most relevant negative cases, which do not contain the finding but may have visual similarities. This retrieval process can allow users to inspect reference cases, assess AI similarity rankings, and validate the system's interpretation of medical images. Explainability interface 902 can further allow clinicians to interact with AI-generated findings by reviewing how well retrieved reference cases align with query image features. Through this interaction, users can confirm or reject AI predictions, refine similarity assessments, and provide direct feedback on the relevance of selected reference cases. Explainability interface 902 can also enable users to adjust certainty thresholds, correct misclassifications, or disable AI annotations if they are deemed inaccurate or misleading. Explainability interface 902 can support a continuous learning feedback loop, allowing user interactions to improve AI model performance over time. If a clinician modifies similarity rankings, corrects detected findings, or highlights cases of low diagnostic quality, explainability interface 902 can transmit this feedback to the SSL training process, enabling the AI model to refine embedding representations, similarity scores, and certainty assessments. By incorporating user feedback, explainability interface 902 can improve the accuracy of retrieved cases, optimize quality meter scoring, and enhance AI-driven decision support in medical imaging workflows. Additionally, explainability interface 902 can detect low diagnostic quality images based on user input, identifying cases where poor resolution, incorrect anatomical positioning, or imaging artifacts compromise the reliability of AI-generated findings. Users can provide feedback indicating whether a scan does not meet clinical quality standards, prompting the system to flag the data and prevent unreliable AI-assisted assessments. By integrating quality control mechanisms, explainability interface 902 can ensure that AI-generated findings are both interpretable and clinically actionable.

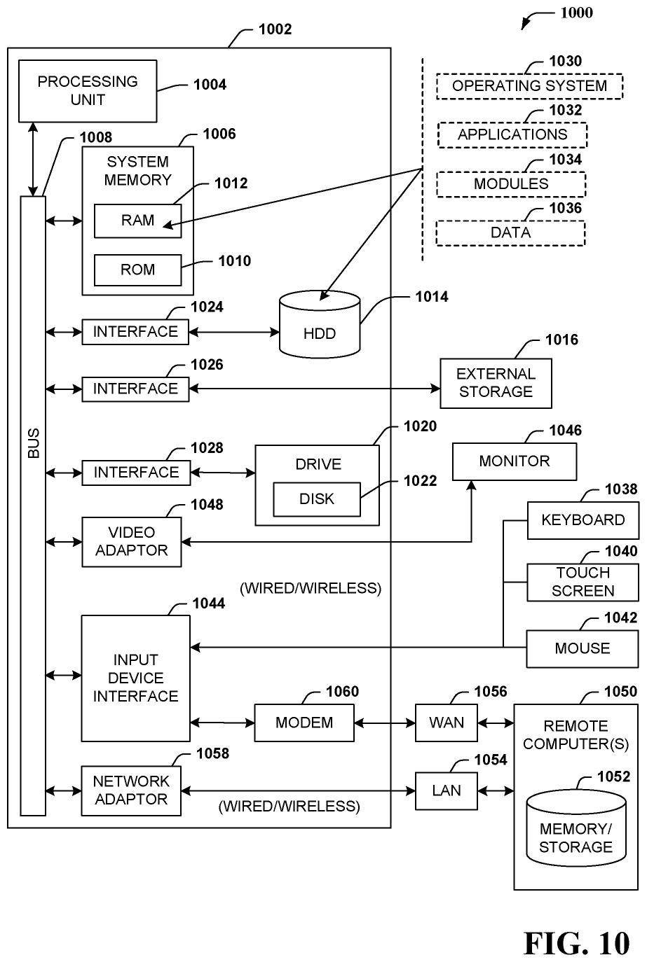

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can also be implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

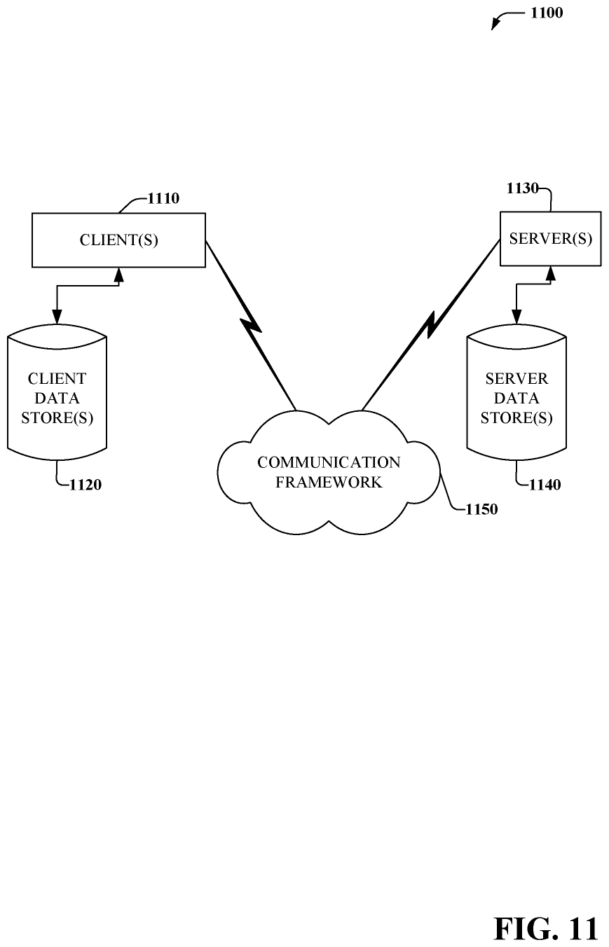

FIG. 11 is a schematic block diagram of a sample computing environment 1100 with which the disclosed subject matter can interact. The sample computing environment 1100 includes one or more client(s) 1110. The client(s) 1110 can be hardware or software (e.g., threads, processes, computing devices). The sample computing environment 1100 also includes one or more server(s) 1130. The server(s) 1130 can also be hardware or software (e.g., threads, processes, computing devices). The servers 1130 can house threads to perform transformations by employing one or more embodiments as described herein, for example. One possible communication between a client 1110 and a server 1130 can be in the form of a data packet adapted to be transmitted between two or more computer processes. The sample computing environment 1100 includes a communication framework 1150 that can be employed to facilitate communications between the client(s) 1110 and the server(s) 1130. The client(s) 1110 are operably connected to one or more client data store(s) 1120 that can be employed to store information local to the client(s) 1110. Similarly, the server(s) 1130 are operably connected to one or more server data store(s) 1140 that can be employed to store information local to the servers 1130.

Various embodiments can be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The disclosure herein describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, wherein the computer-executable components comprise:
an inference component that processes medical data and encodes the medical data, including a detected finding and a corresponding region of interest, into a joint embedding space as an embedding representation generated by a representation learning model;
a score component that quantifies a similarity between a query image and at least one reference case and generates a quality score, wherein the score component is configured to compute distances in the joint embedding space between a query embedding associated with the detected finding and embeddings associated with a plurality of positive reference cases and a plurality of negative reference cases, to weight the computed distances, and to normalize a weighted result to generate the quality score within a predefined bounded scale;
a diagnostic support component that retrieves representative cases pertaining to the detected finding and compares the representative cases with the embedded representation of the detected finding to determine a diagnostic quality of the detected finding;
an artificial intelligence component that trains the representation learning model to map medical images and corresponding regions of interest into the joint embedding space such that embeddings associated with similar clinical findings are positioned closer together and embeddings associated with dissimilar clinical findings are positioned farther apart; and
a training component that updates one or more parameters of the representation learning model based on at least one of user feedback associated with the retrieved representative cases, relevance of the positive reference cases and the negative reference cases, or determinations of diagnostic quality, wherein updating the one or more parameters modifies spatial relationships within the joint embedding space to increase separation between embeddings associated with the positive reference cases and embeddings associated with the negative reference cases for subsequent similarity quantification.

2. The system of claim 1, wherein the medical data further comprises single-frame images, volumetric image data, or time-series imaging data acquired from a medical imaging modality.

3. The system of claim 1, wherein the detected finding further comprises an anatomical structure, a pathological feature, a lesion, a tumor, a fracture, a hemorrhage, or a fluid accumulation.

4. The system of claim 1, wherein the representation learning model comprises a convolutional neural network, a vision transformer, a Siamese network, or a hybrid deep neural network architecture configured to generate high-dimensional embedding vectors.

5. The system of claim 1, wherein computing the distances in the joint embedding space comprises computing cosine similarity, Euclidean distance, or Mahalanobis distance between the query embedding and the embeddings associated with the plurality of positive reference cases and the plurality of negative reference cases.

6. The system of claim 1, wherein weighting the computed distances comprises applying different weighting factors to distances associated with the positive reference cases and distances associated with the negative reference cases.

7. The system of claim 1, wherein normalizing the weighted result comprises scaling the weighted result to a bounded diagnostic certainty scale ranging from a lower threshold representing weak similarity to an upper threshold representing strong similarity.

8. The system of claim 1, wherein the diagnostic support component determines low diagnostic quality based on at least one of image resolution, contrast, noise levels, anatomical positioning, or presence of imaging artifacts.

9. The system of claim 8, wherein the diagnostic support component identifies a deviation of anatomical positioning from predefined anatomical landmarks associated with the detected finding and flags the medical data as low diagnostic quality.

10. The system of claim 9, wherein the diagnostic support component generates an alert or recommendation in response to identifying the medical data as low diagnostic quality.

11. The system of claim 1, wherein retrieving the representative cases comprises selecting reference cases having embeddings that are closest to the query embedding among the plurality of positive reference cases and reference cases having embeddings that are furthest from the query embedding among the plurality of negative reference cases within the joint embedding space.

12. The system of claim 1, wherein the artificial intelligence component trains the representation learning model using contrastive learning or metric learning to minimize distances between embeddings associated with similar clinical findings and maximize distances between embeddings associated with dissimilar clinical findings.

13. The system of claim 1, wherein the training component updates the one or more parameters of the representation learning model by fine-tuning embedding vectors or similarity weighting factors in response to the user feedback to reduce false positive similarity matches in subsequent similarity quantification.

14. The system of claim 1, further comprising a user-interface component configured to receive the user feedback and to provide an interactive visualization of the retrieved representative cases and the quality score, wherein the user feedback is provided to the training component for updating the one or more parameters of the representation learning model.

15. The system of claim 1, wherein the quality score generated by the score component corresponds to a discrete multi-level quality meter comprising a predefined number of ordered certainty levels, wherein each certainty level is associated with a respective similarity strength determined from relative distances between the query embedding and the embeddings associated with the plurality of positive reference cases and the plurality of negative reference cases.

16. A computer-implemented method, comprising:
processing, by a device operatively coupled to a processor, medical data;
accessing, by the device, an embedded representation of a detected finding or a corresponding region of interest;
quantifying, by the device, a similarity between a query image and an at least one reference case;
generating, by the device, a quality score;
retrieving, by the device, representative cases for the detected finding;
comparing, by the device, the representative cases with the medical data; and
determining, by the device, a diagnostic quality of the data.

17. The method of claim 15, wherein the medical data further comprises single-frame images, volumetric data, or time-series data from dynamic imaging, and wherein the detected finding further comprises an anatomical structure, a medical feature, anomaly, or condition.

18. The method of claim 16, wherein the quantifying the similarity between the query image and the at least one reference case further comprises computing a similarity score using an AI-driven similarity metric.

19. The method of claim 18, wherein computing the similarity score further comprises evaluating distances between a query embedding and reference cases, weighing the distances, and normalizing a result within a predefined scale to indicate a relevance of a match.

20. A computer program product for facilitating medical image analysis and similarity-based retrieval, the computer program product comprising a non-transitory computer-readable memory having program instructions embodied therewith, the program instructions executable by a processor to cause the processor to:
process medical data;
access an embedded representation of a detected finding or a corresponding region of interest;
quantify a similarity between a query image and an at least one reference case;
generate a quality score;
retrieve representative cases for the detected finding;
compare the representative cases with the medical data; and
determine a diagnostic quality of the medical data.
